(19) United States
(12) Patent Application Publication
(10) Pub. No.: US 2025/0348666 A1
(43) Pub. Date: Nov. 13, 2025

(54) GOAL-DRIVEN INCIDENT SUMMARIZATION

(71) Applicant: International Business Machines Corporation, Armonk, NY (US)

(72) Inventors: Suranjana Samanta, Bangalore (IN); Prateeti Mohapatra, Bangalore (IN); Oishik Chatterjee, Kolkata (IN); Simao Liu, San Jose, CA (US); Ruchi Mahindru, Elmsford, NY (US); Yu Deng, Yorktown Heights, NY (US); Neil H. Boyette, Oregon City, OR (US); Rakesh Ranjan, Santa Clara, CA (US); ARTHUR DE MAGALHAES, Markham (CA); Pooja Aggarwal, Bengaluru (IN)

(21) Appl. No.: 18/657,099

(22) Filed: May 7, 2024

(51) Int. Cl. G06F 40/205; G06F 40/166; G06F 40/253; G06F 40/279; G06F 40/30

(52) U.S. Cl. CPC G06F 40/205; G06F 40/166; G06F 40/253; G06F 40/279; G06F 40/30

(57) ABSTRACT

A computer-implemented method includes parsing, by a processor set, text comprised by an alert corresponding to an information technology (IT) abnormality incident, resulting in alert data. The processor set uses a generative machine learning (ML) model to generate a natural language summary of the incident. The natural language summary includes a symptom-resource pairing corresponding to the alert and is based on the alert data and on a topology of keywords comprised by the alert. In one or more embodiments, the computer-implemented method further comprises employing, by the processor set, graph connectivity distances between elements of the topology to verify the symptom-resource pairing.

### STATEMENT REGARDING PRIOR DISCLOSURES BY THE INVENTORS

The following disclosures are submitted under 35 U.S.C. 102(b)(1)(A):
DISCLOSURE: SAMANTA et al., “InsightsSumm: Summarization of ITOps Incidents through In-Context Prompt Engineering”, 2023 IEEE 16th International Conference on Cloud Computing (CLOUD), Chicago, IL, USA, July 2023, pp. 290-292, doi: 10.1109/CLOUD60044.2023.00041.
DISCLOSURE: SAMANTA et al., “Incident Summarization for Better Insights and Understanding”, LinkedIn article, January 2024, six pages.

### BACKGROUND

The subject disclosure relates to use of multi-modal data for generating an incident report corresponding to abnormal computer system activity.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein provide for goal-driven summarization of faults of a computer system (e.g., physical, cloud-based and/or virtual, without being limited thereto), based on heterogenous multi-modal data.

In accordance with an embodiment, a computer-implemented method comprises parsing, by natural language processing techniques, text of an alert corresponding to an information technology (IT) abnormality incident, resulting in alert data; and generating a generative machine learning (ML) model, a natural language summary of the incident, wherein the natural language summary comprises a symptom-resource pairing corresponding to the alert and is based on the alert data and on a topology of keywords of the alert. A computer system and a computer program product each configured to execute code or to cause the execution of code so that the above-described method is conducted also are provided in accordance with other embodiments.

### DESCRIPTION OF THE DRAWINGS

The technology described herein is illustrated by way of example and not limited in the accompanying figures in which like reference numerals indicate similar elements.

FIG. 1 illustrates a block diagram of an example, non-limiting system that provides a process to summarize heterogenous incident-related information, in accordance with one or more embodiments described herein.

FIG. 2 illustrates a block diagram of another example, non-limiting system that provides a process to summarize heterogenous incident-related information, in accordance with one or more embodiments described herein.

FIG. 3 illustrates a high-level schematic diagram of exemplary processes that are performed by the non-limiting system of FIG. 2, in accordance with one or more embodiments described herein.

FIG. 4 illustrates another high-level schematic diagram of exemplary processes that are performed by the non-limiting system of FIG. 2, in accordance with one or more embodiments described herein.

FIG. 5 illustrates a schematic diagram of exemplary summarization processes that are performed by the non-limiting system of FIG. 2, in accordance with one or more embodiments described herein.

FIG. 6A provides a diagram illustrating an exemplary summarization process that is performed by the non-limiting system of FIG. 2, in accordance with one or more embodiments described herein.

FIG. 6B provides a diagram illustrating symptom detection and resource-symptom pairing that are performed by the non-limiting system of FIG. 2, in accordance with one or more embodiments described herein.

FIG. 7 illustrates a schematic diagram of one or more artificial intelligence for information technology operations (AIOps) metric feedback evaluation processes that are performed by the non-limiting system of FIG. 2, in accordance with one or more embodiments described herein.

FIG. 8 illustrates a schematic diagram of one or more high level feedback evaluation processes that are performed by the non-limiting system of FIG. 2, in accordance with one or more embodiments described herein.

FIG. 9 illustrates a schematic diagram of one or more remedy generation processes that are performed by the non-limiting system of FIG. 2, in accordance with one or more embodiments described herein.

FIG. 10 illustrates another schematic diagram of one or more remedy generation processes that are performed by the non-limiting system of FIG. 2, in accordance with one or more embodiments described herein.

FIG. 11 illustrates a flow diagram of one or more processes performed by the non-limiting system of FIG. 2, in accordance with one or more embodiments described herein.

FIG. 12 illustrates another flow diagram of one or more processes performed by the non-limiting system of FIG. 2, in accordance with one or more embodiments described herein.

FIG. 13 illustrates a continuation of the flow diagram of FIG. 12 of one or more processes that are performed by the non-limiting system of FIG. 2, in accordance with one or more embodiments described herein.

FIG. 14 illustrates a continuation of the flow diagram of FIG. 13 of one or more processes that are performed by the non-limiting system of FIG. 2, in accordance with one or more embodiments described herein.

FIG. 15 illustrates a continuation of the flow diagram of FIG. 14 of one or more processes that are performed by the non-limiting system of FIG. 2, in accordance with one or more embodiments described herein.

FIG. 16 illustrates a block diagram of example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In practice, increase in information technology (IT) deployments and cloud adoption, often owing to rapidly increasing digitization, leads to various challenges in various IT settings. These various challenges include how to derive insights from heterogeneous data coming from disparate sources (e.g., metrics, logs, alerts, anomalies and/or topology) and from application lifecycle stages to help report and/or remediate a failure or other incident.

For example, existing frameworks use an incidents insights dashboard to collate and view key insights for a given incident. Such dashboard comprises an overview tab presenting top probable causes and related historical tickets, an alerts tab including alerts associated with the fault, and a topology tab showing the relationships of impacted resources, which together constitute a context associated with a fault. However, with rich and exhaustive context present on the dashboards, it is challenging and time-consuming to consume and comprehend the key insights.

That is, existing frameworks using multi-modal data for generating an incident report corresponding to abnormal computer system activity are cumbersome, time consuming, manually driven, inaccurate and/or inefficient. As a result, existing frameworks for determining individual faults, fault patterns and/or root cause, and/or linking one or more aspects of the multi-modal data (e.g., heterogenous data) to one or more faults, are generally ineffective. It is desired to more quickly, efficiently and/or automatically generate data corresponding to meaningful fault insights based on the multi-modal data.

To account for one or more of the aforementioned deficiencies of existing frameworks to effectively and/or efficiently provide for goal-driven summarization of computer system faults based on heterogenous multi-modal data, the one or more frameworks disclosed herein provide for automatic or at least partially automatic generation of one or more of an alert summary, a customized summary for a specified user entity, and/or a customized summary for a specified group of user entities. In one or more embodiments, the summary comprises any one or more of an identification of abnormal computer system activity, a correlation between the abnormal computer system activity and one or more aspects of multi-modal data, a notification of the abnormal computer system activity, and/or a suggested remedy for responding to the abnormal computer system activity. Additionally, and/or alternatively, in one or more embodiments, a non-limiting system described herein directs and/or causes an operation and/or action to respond to the abnormal computer system activity.

That is, given heterogeneous insights/context data around an incident (e.g., faults, anomalies and alerts with their details, topology information, evidences, etc.), in one or more embodiments, an abstractive summary is generated through artificial intelligence and prompt engineering. This abstractive summary serves as an input to perform various downstream tasks such as query generation, question answering, ticket generation, prompt design for code generation, and/or remedy generation.

As used herein, an “incident” refers to a fault at a computer system, where the fault is caused by activity specified as being atypical and/or abnormal. The term “IT abnormality incident” therefore refers to an incident. In one or more cases, the fault occurs at any level of a computer system (e.g., physical, cloud-based and/or virtual, without being limited thereto) comprising a plurality of nodes, where each node comprises one or more computer devices, such as processors, servers and/or the like. In one or more cases, a level of abnormality is specified by a user entity, such as based on historical data, and/or by using an abnormality level threshold and/or other ranking system.

In one or more embodiments, an incident refers to an artificial intelligence (AI) hallucination, which is defined as an incorrect and/or misleading result generated by an AI element, such as an AI model. In one or more existing frameworks, such hallucination is referred to as a ghost aspect. Such hallucination is caused by any one or more factors comprising, but not limited to, insufficient training data, incorrect assumption employed by the AI element, and/or a bias of the training data.

Turning now briefly to the natural language summary, a generated natural language summary provided by a non-limiting system described herein is based on any one or more of use of an artificial intelligence for IT operations (AIOps)-specific evaluation metric, determination of a symptom-resource pairing, and/or use of user entity feedback. In one or more embodiments, different generated summaries provide different categories of information based on specified user entity preferences. For example, user entity preferences comprise default templates, information aspects of importance, information layout, summary generation frequency, and/or the like.

In one or more cases, the one or more embodiments described herein function with AIOps-based heterogeneous data, such as comprising, but not limited to, data corresponding to one or more alerts, data using text comprising frequently-used and/or non-frequently-used phrases, data where limited because no exemplary corresponding historical data is available at day zero of implementation of a non-limiting system, and/or the like.

In one or more embodiments, a non-limiting system described herein additionally, and/or alternatively, performs any one or more of the following operations: evaluating the quality of the generated summary using an AIOps-specific proposed metric that detects hallucination in and/or based on the multi-modal data; improving an output summary by feedback from a user entity; improving proposed metric values by training an AI element, such as an AI model, and/or template; receiving from an AI information technology operations (ITops) system an alert corresponding to a fault (also herein referred to as an incident) at a cloud computing system, the alerts comprising a probable cause; filtering the alerts by applying natural language processing to produce filtered probable cause alerts and filtered other alerts; combining the filtered probable cause alerts to produced combined probable cause alerts; combining the filtered other alerts to produce combined other alerts; putting the combined probable cause alerts into a language machine learning model such that that, in response, the language machine learning model outputs first grammatically correct sentences describing the probable cause alerts; inputting the combined other alerts into the language machine learning model such that that, in response, the language machine learning model outputs second grammatically correct sentences describing the other alerts; inputting the first grammatically correct sentences and a natural language task instruction into a generative machine learning model such that, in response, the generative machine learning model outputs a first summary of the first grammatically correct sentences; inputting the second grammatically correct sentences and the natural language task instruction into the generative machine learning model such that, in response, the generative machine learning model outputs a second summary of the second grammatically correct sentences; and combining the first summary, the second summary, and information regarding golden signals to produce a combined summary; providing future fault prediction; and self-improving training based on historical data and/or data corresponding to one or more occurrences of a recent fault.

As used herein, “golden signals” are key performance indicators (KPIs) that are used to monitor and/or analyze the health of a computer system. These golden signals comprise error, saturation, latency, and traffic, without being limited thereto.

A benefit of the one or more systems, computer program products and/or computer-implemented methods is an ability to automatically provide an incident abstract summarization based on heterogenous data from disparate sources without intensive manual input per incident abstract summarization. That is, automatic provision is provided using an artificial intelligence model (e.g., a machine learning model, neural network, etc.) based on one or more of a plurality of different inputs. These inputs comprise, but are not limited to, entity-specific behavioral feedback, artificial intelligence for information technology operations (AIOps) metric feedback and/or historical incident-based feedback.

Still another benefit of the one or more systems, computer program products and/or computer-implemented methods is an ability to provide user entity-specific summaries comprising varying templates, information classifications, information organizations, wording and/or the like. That is, the NL summary generated is tailored based on a database of user entity preferences.

Yet another benefit of the one or more systems, computer program products and/or computer-implemented methods is use of the summary, and a database of historical incident information, a database of indicators to further provide one or more remedies that are performed to address the incident/alert. In one or more embodiments, the one or more suggested remedies are included in the entity-specific summary.

As used herein, the term “data” comprises metadata.

As used herein, the terms “entity,” “requesting entity,” “user entity,” and “administrating entity” refer to a machine, device, component, code, hardware, software, smart device, party, organization, individual and/or human.

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, codes, devices and/or components depicted therein, nor to any particular order, connection and/or coupling of systems, codes, devices and/or components depicted therein.

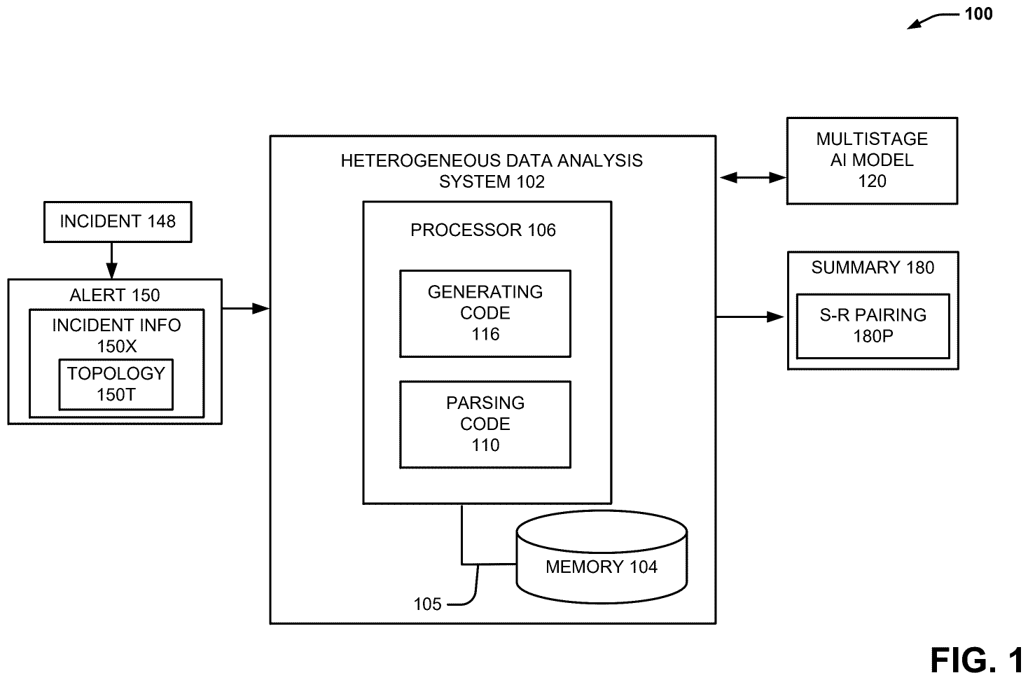

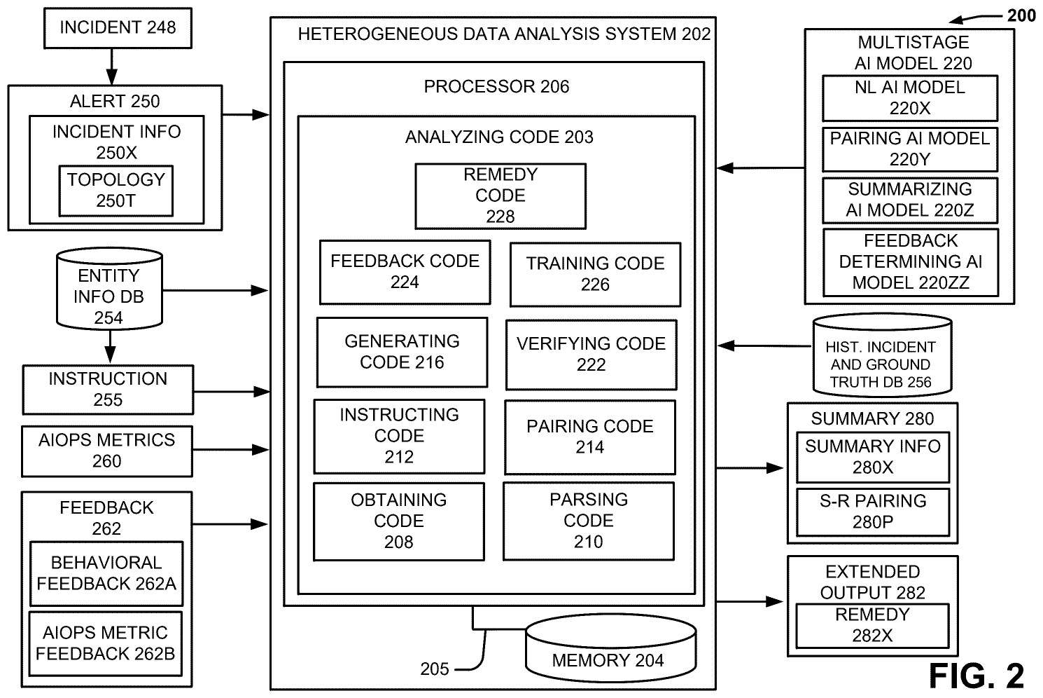

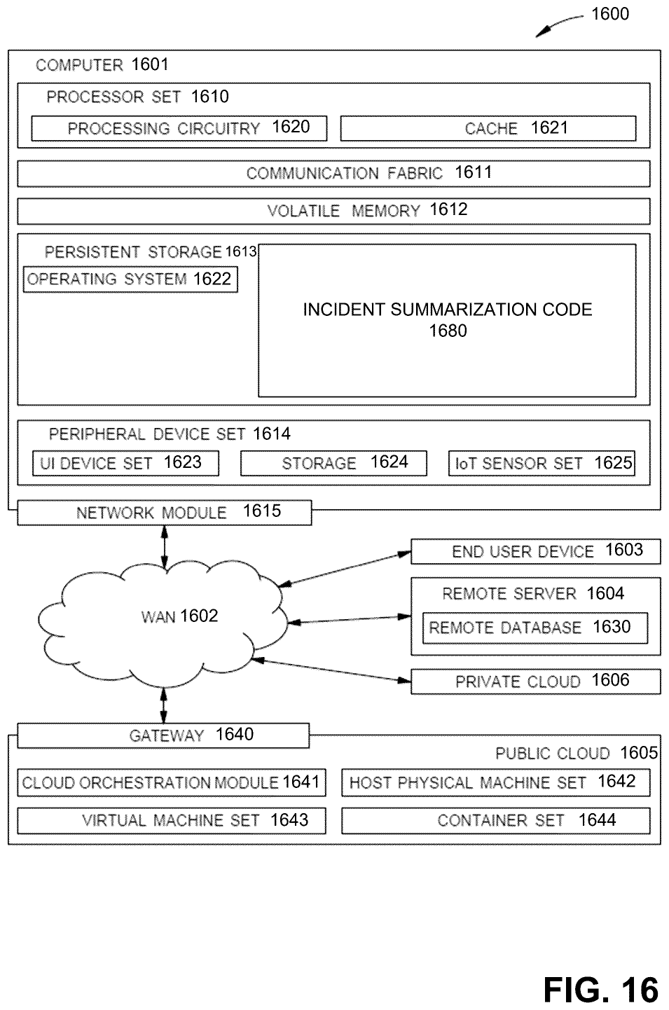

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1600 illustrated at FIG. 16. In one or more described embodiments, computer and/or computing-based elements can be used in connection with implementing one or more of the systems, devices, codes, components and/or computer-implemented operations shown and/or described in connection with FIGS. 1 and/or 2 and/or with one or more other figures described herein.

Turning now in particular to one or more figures, and first to FIG. 1, the figure illustrates a block diagram of an example, non-limiting system 100 that facilitates goal-driven summarization of faults of a computer system (e.g., physical, cloud-based and/or virtual, without being limited thereto), based on heterogenous multi-modal data. That is, the non-limiting system 100 facilitates a process to generate a natural language (NL) summary describing an incident having occurred at and/or within a computer system. In one or more embodiments, the description is tailored to a particular user entity preference. In one or more embodiments, the system 100 additionally and/or alternatively suggests and/or directs implementation of a remedy to address and/or correct the incident based on the generated NL summary.

The non-limiting system 100 comprises a heterogeneous data analysis system 102. It is noted that the heterogeneous data analysis system 102 is only briefly detailed to provide but a lead-in to a more complex and/or more expansive heterogeneous data analysis system 202 as illustrated at FIG. 2. That is, further detail regarding processes performed by one or more embodiments described herein will be provided below relative to the non-limiting system 200 of FIG. 2.

Still referring to FIG. 1, the heterogeneous data analysis system 102 comprises at least a memory 104, bus 105, processor 106 of a processor set of one or more processors, parsing code 110, multistage AI model 120 and/or generating code 116. Using these codes 110, 116, the heterogeneous data analysis system 102 generates the NL summary 180 to at least partially respond to an incident 148 that took place at the non-limiting system 100 and/or at any other computer system communicatively coupled to the non-limiting system 100.

The parsing code 110 generally parses text of the alert 150 corresponding to an information technology (IT) abnormality incident 148, resulting in alert data (e.g., incident information 150X).

The generating code 116 generally generates, using a generative machine learning (ML) model (e.g., a multistage AI model 120), the natural language summary 180 of the alert 150. In one or more embodiments, the multistage AI model 120 is and/or comprises the generative ML model, and/or in one or more other embodiments comprises any other artificial intelligence model, neural network, machine learning model, etc. The NL summary 180 comprises a symptom-resource pairing (S-P pairing) 180P corresponding to the alert 150. This S-P pairing 180P describes a symptom of the incident 148 and a resource related to causation of the incident 148. The S-P pairing 180P is based on the alert data and on a topology of keywords comprised by the alert.

In one or more embodiments, the parsing code 110, multistage AI model 120 and/or generating code 116 are operatively coupled to a processor 106 of a processor set of one or more processors, one or more of which are operatively coupled to a memory 104. The bus 105 provides for the operative coupling. The memory 104 stores the parsing code 110 and the generating code 116. The processor 106 facilitates execution of the parsing code 110, multistage AI model 120 and/or generating code 116. In one or more embodiments, the parsing code 110, multistage AI model 120 and/or generating code 116 are stored so as to be accessible to the processor 106 and/or at any processor of the processor set, together or separately from one another. In one or more embodiments, the parsing code 110, multistage AI model 120 and/or generating code 116 are all encompassed by the incident summarization code 1680 that is described subsequently with respect to FIG. 16.

In general, the non-limiting system 100 employs any suitable method of communication (e.g., electronic, communicative, internet, infrared, fiber, etc.) to provide communication between the heterogeneous data analysis system 102 and a computer system in which the incident 148 occurred.

Turning next to FIG. 2, a non-limiting system 200 is illustrated that comprises a heterogeneous data analysis system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the heterogeneous data analysis system 202 facilitates goal-driven summarization of faults of a computer system (e.g., physical, cloud-based and/or virtual, without being limited thereto), based on heterogenous multi-modal data. That is, the non-limiting system 100 facilitates a process to generate a natural language (NL) summary describing an incident having occurred at and/or within a computer system. In one or more embodiments, the description is tailored to a particular user entity preference. In one or more embodiments, the system 200 additionally and/or alternatively suggests and/or directs implementation of a remedy to address the incident based on the generated NL summary.

In one or more embodiments, one or more communications between one or more aspects of the non-limiting system 200 are provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

In one or more embodiments, the heterogeneous data analysis system 202 is associated with, e.g., is accessible via, a cloud computing environment.

In one or more embodiments, the heterogeneous data analysis system 202 comprises a plurality of physical and/or non-physical aspects. The aspects comprise a memory 204, processor 206 of a set of one or more processors, bus 205, obtaining code 208, parsing code 210, instructing code 212, pairing code 214, generating code 216, multistage AI model 220, verifying code 222, feedback code 224, training code 226 and/or remedy code 228. In one or more embodiments, all or some of these codes and the AI mode of the heterogeneous data analysis system 202 are encompassed by the incident summarization code 1680 that is described subsequently with respect to FIG. 16. Using the codes, the heterogeneous data analysis system 202 performs the summary generation and subsequent remedy suggesting/directing using a dynamically adjustable multistage AI model 220. The multistage AI model 220 is dynamically adjustable based on a feedback process using feedback 262 employed by the feedback code 224 to adjust the multistage AI model 220 for higher accuracy and/or precision of identification of symptoms, resources and/or symptom-resource pairings (S-R pairings) 280P. Accordingly, the heterogeneous data analysis system 202 is self-improving through these feedback and re-training processes.

As used herein, “accuracy” refers to closeness of an output to an accepted value, e.g., how close a symptom, resource and/or S-R pairing is to a user-specified aspect of a historical value, for example. As used herein, “precision” refers to closeness of measurements of the same aspect to one another. For example, “precision” refers to whether repeated topology keywords or golden signals from the incident information 250X are each referenced similarly in the summary information 280X. In one or more embodiments described herein, accuracy and precision are verified by the verifying code 222, to be described below in detail.

Discussion next turns briefly to the processor 206, memory 204 and bus 205 of the heterogeneous data analysis system 202. For example, in one or more embodiments, the heterogeneous data analysis system 202 comprises the processor 206 (e.g., computer processing unit, microprocessor, classical processor, quantum processor and/or like processor). Again, it is noted that, in one or more embodiments, the heterogeneous data analysis system 202 comprises a processor set (of one or more processors) comprising the processor 206 and can, in one or more embodiments, comprise one or more additional processors of the set. In one or more embodiments, a code associated with heterogeneous data analysis system 202, as described herein with or without reference to the one or more figures of the one or more embodiments, is and/or comprises one or more computer and/or machine readable, writable and/or executable codes and/or instructions that are executed by processor 206 to provide performance of one or more processes defined by such code and/or instruction. In one or more embodiments, the processor 206, and/or one or more other processors 206 of the processor set (e.g., relative to distribution or not amongst the processor set) are able to access the obtaining code 208, parsing code 210, instructing code 212, pairing code 214, generating code 216, multistage AI model 220, verifying code 222, feedback code 224, training code 226 and/or remedy code 228 from the memory 204 in order to be able to execute the code.

In one or more embodiments, the heterogeneous data analysis system 202 comprises the computer-readable memory 204 that is operably connected to the processor 206. The memory 204 stores computer-executable instructions that, upon execution by the processor 206, causes the processor 206 and/or one or more codes of the heterogeneous data analysis system 202 (e.g., obtaining code 208, parsing code 210, instructing code 212, pairing code 214, generating code 216, multistage AI model 220, verifying code 222, feedback code 224, training code 226 and/or remedy code 228) to perform one or more actions. In one or more other, non-illustrated embodiments, the memory 204 stores one or more computer-executable codes (e.g., obtaining code 208, parsing code 210, instructing code 212, pairing code 214, generating code 216, multistage AI model 220, verifying code 222, feedback code 224, training code 226 and/or remedy code 228).

In one or more embodiments, the heterogeneous data analysis system 202 and/or a code thereof as described herein, is communicatively, electrically, operatively, optically and/or otherwise coupled to one another via a bus 205. Bus 205 comprises one or more of a memory bus, memory controller, peripheral bus, external bus, local bus, quantum bus and/or another type of bus that employs one or more bus architectures. One or more of these examples of bus 205 is employed.

In one or more embodiments, the heterogeneous data analysis system 202 is coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the codes of the heterogeneous data analysis system 202 and/or of the non-limiting system 200 reside in the cloud, and/or reside locally in a local computing environment (e.g., at a specified location).

In general, the non-limiting system 200 employs any suitable method of communication (e.g., electronic, communicative, internet, infrared, fiber, etc.) to provide communication between the heterogeneous data analysis system 202 and a computer system in which the incident 248 occurred. In one or more embodiments, the non-limiting system 200 comprises the computer system in which the incident 248 occurred.

In one or more embodiments, in addition to the processor 206 and/or memory 204 described above, the heterogeneous data analysis system 202 comprises one or more computer and/or machine readable, writable and/or executable codes and/or instructions that, when executed by processor 206, provide performance of operations defined by such code and/or instruction.

It is noted that in one or more embodiments, the obtaining code 208, parsing code 210, instructing code 212, pairing code 214, generating code 216, multistage AI model 220, verifying code 222, feedback code 224, training code 226 and/or remedy code 228 are implemented independently, without one or more other of the obtaining code 208, parsing code 210, instructing code 212, pairing code 214, generating code 216, multistage AI model 220, verifying code 222, feedback code 224, training code 226 and/or remedy code 228. Additionally and/or alternatively, the obtaining code 208, parsing code 210, instructing code 212, pairing code 214, generating code 216, multistage AI model 220, verifying code 222, feedback code 224, training code 226 and/or remedy code 228 are comprised by a high-level analyzing code 203, one or more of the below-described functions of the obtaining code 208, parsing code 210, instructing code 212, pairing code 214, generating code 216, multistage AI model 220, verifying code 222, feedback code 224, training code 226 and/or remedy code 228 are performed by the high-level analyzing code 203, and/or the obtaining code 208, parsing code 210, instructing code 212, pairing code 214, generating code 216, multistage AI model 220, verifying code 222, feedback code 224, training code 226 and/or remedy code 228 are omitted with the high-level analyzing code 203 performing one or more of the below-described functions of the one or more omitted obtaining code 208, parsing code 210, instructing code 212, pairing code 214, generating code 216, multistage AI model 220, verifying code 222, feedback code 224, training code 226 and/or remedy code 228.

Turning now to the various codes of the heterogeneous data analysis system 202 (e.g., obtaining code 208, parsing code 210, instructing code 212, pairing code 214, generating code 216, multistage AI model 220, verifying code 222, feedback code 224, training code 226 and/or remedy code 228), generally, the heterogeneous data analysis system 202 performs one or both of NL summary 280 generation and remedy 282X suggesting and/or directing.

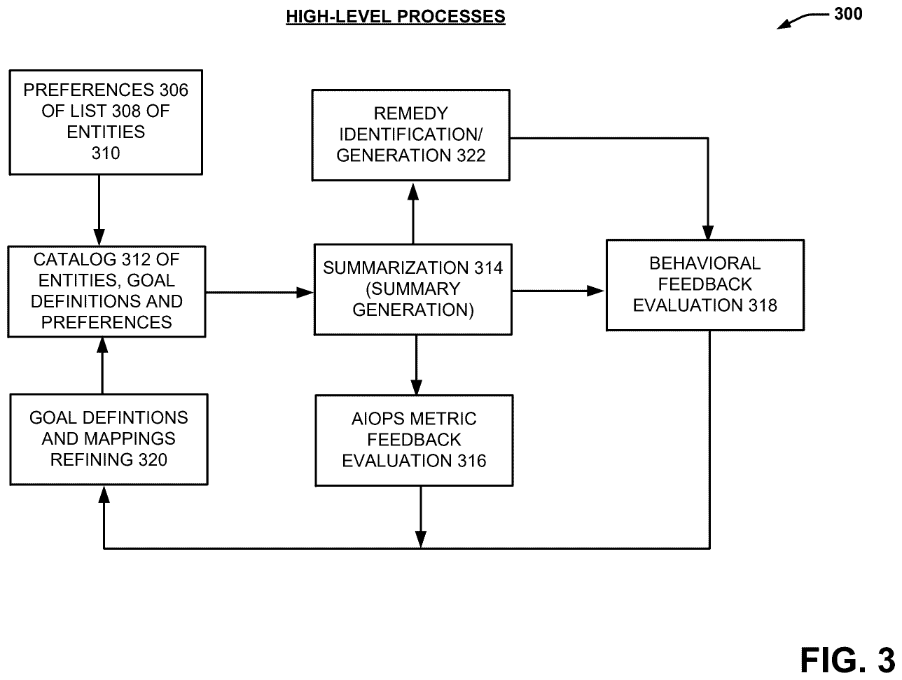

For example, turning briefly to FIG. 3, and still referring to FIG. 2, a schematic block diagram 300 is provided illustrating a set of high-level processes that are performed by the heterogeneous data analysis system 202. As illustrated, in one or more embodiments, heterogeneous data analysis system 202 performs a summarization process 314 using an output of a feedback process (e.g., output from a goal definitions and mappings refining process 320) and also using a catalog 312 of entities, goal definitions and mappings. This catalog 312 is based on, provided by and/or defines one or more preferences 306 of entities 310 of a list 308 of the entities, thereby allowing for tailoring of the summarization process 314 to one or more of the entities 310. The above-noted feedback that is provided includes one or both of a behavioral feedback evaluation 318 based on input from one or more of the entities 310 and/or an artificial intelligence for information technology operations (AIOps) metric feedback evaluation 316. Also, as illustrated, based on the summarization process 314, a remedy identification/generation process 322 is subsequently performed. These processes will each be described in detail below relative to subsequent figures.

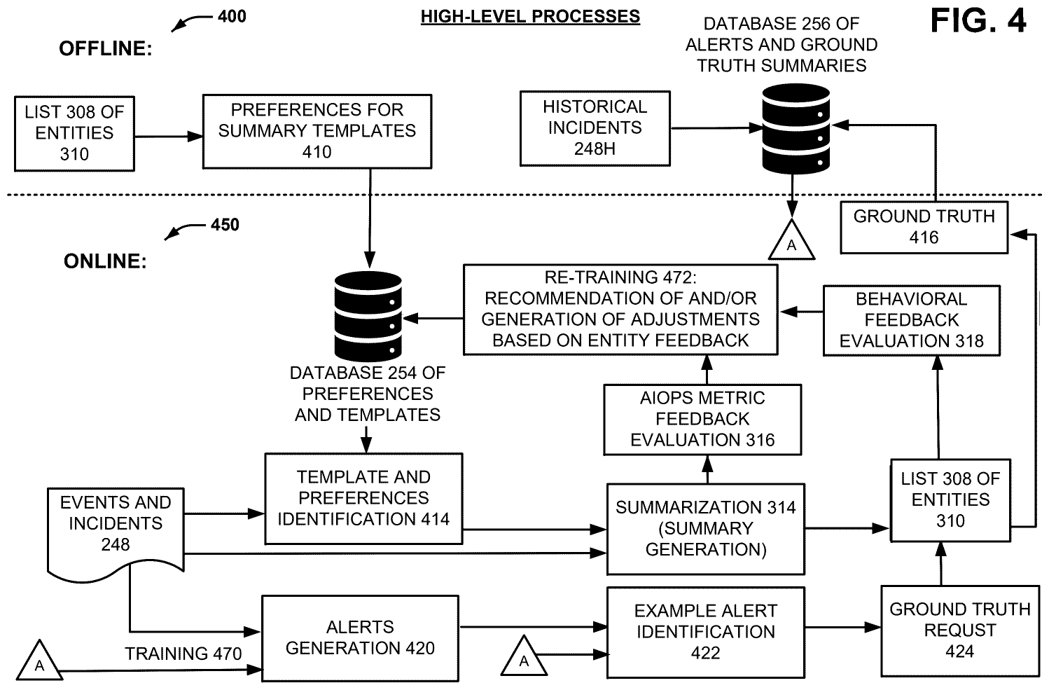

Next, turning to FIG. 4, and still referring to FIG. 2, a schematic block diagram is provided illustrating an increased granularity (as compared to FIG. 3) of high-level processes that are performed offline (e.g., offline processes 400) and/or online (e.g., online processes 500) relative to the heterogeneous data analysis system 202. It is noted that in one or more embodiments, any one or more of the offline processes 400 are performed as online processes 500 (e.g., by the heterogeneous data analysis system 202 and not separately from/external to the heterogeneous data analysis system 202).

First, the multistage AI model 220 is initially trained (e.g., training 470 at FIG. 4). In one or more embodiments, the multistage AI model 220 is a generative ML model, and/or in one or more other embodiments, comprises any other artificial intelligence model, neural network, machine learning model, etc. As used herein, the term “generative” refers to a ML model that is a statistical model configured to generate new data instances (e.g., new symptom, resource and/or S-R pairing instances) and that captures probability (e.g., joint probability) of a plurality of factors (e.g., the symptoms and resources). The probability capturing comprises predicting and/or indicating likeliness of a symptom, resource and/or pairing of symptom and resource based on a distribution of data (e.g., based on incident information 250X). This probability capturing is performed based on a modelling of a distribution of likely symptoms, resources and/or S-R pairings 280P by the generative ML model (e.g., the multistage AI model 220) throughout a data space including the incident information 250X and/or historical prompt information (e.g., from database 256 describing historical incidents 248H). As used herein, the term “prompt” refers to alert information and “prompt generation” refers to the process of generating alert information.

In one or more embodiments, any one or more of the NL AI model 220X, pairing AI model 220Y, summarizing AI model 220Z, and/or feedback determining AI model 220ZZ are AI models of the multistage AI model 220.

In one or more embodiments, the multistage AI model 220 performs a non-limiting process with individual processing stages performed by one or more of the AI models 220X-ZZ, and each processing stage of the multistage AI model 220 is executed by an individual AI model 220X-ZZ. Particular processes of processing stages of the AI models 220X-ZZ are described below relative to their use and/or performance.

The training processes 470 include a generation 420 of alerts and/or a set of data (e.g., prompts) to be employed for generating alerts external to the training processes 470. The training processes 470 also comprise example alert identification 422 based on the alert data output from alert generation 420. These processes are facilitated by the training code 226. The training code 226 and/or another suitable aspect of the heterogeneous data analysis system 202 generates a ground truth request 424, which comprises a proposed ground truth that is to be responded to and/or approved using entity feedback, such as behavioral feedback evaluation 318. Approved ground truths 416 are stored at the alert/prompt/historical database 256 of alerts and ground truth summaries for use by the heterogeneous data analysis system 202 (e.g., by the multistage AI model 220) during non-training cycles. This storing is implemented by the training code 226.

Turning now to the offline processes 400, the obtaining code 208 receives, identifies, requests, retains, stores, discovers and/or otherwise generally obtains the preferences 410 for summary templates (e.g., templates upon which the summaries 280 are based). The preferences 410 are obtained from, and/or from a computer system communicatively coupled to, the non-limiting system 200, and/or from a device associated with a user entity 310. The obtaining code 208 facilitates the storing of the preferences 410 in the entity information database 254 of preferences and templates.

It is noted that, in one or more embodiments, the entity information database 254 and/or alert/prompt/historical database 256 is part of the non-limiting system 200 and/or stored at any other location communicatively accessible by the non-limiting system 200.

Turning now to the online processes 450, relative to operating of the trained heterogeneous data analysis system 202, the obtaining code 208 generally obtains the alert 250 that describes the incident 248 using incident information 250X. In one or more cases, the incident information comprises topological information, detected anomalies and/or probable cause identification. In one or more cases, the incident information 250X comprises information describing context from one or more different end-points or resources. In one or more cases, one or more incidents 248 are reported by one alert 250. The alert 250 is any suitable format (e.g., text, code, log, matrix, etc.) and comprises data and/or metadata. The obtaining code 208 receives, identifies, requests, retains, stores, discovers and/or otherwise generally obtains the alert 250. The alert 250, as noted above, is obtained from, and/or from a computer system communicatively coupled to, the non-limiting system 200.

The instructing code 212 employs the entity information database 254 and the incident information 250X of the alert 250 to identify (e.g., template and preferences identification 414) one or more templates and/or user entity preferences from the entity information database 254. In connection with the identifying, the instructing code 212 generates an instruction 255 to be employed by the generating code 216 and/or multistage AI model 220 for generating the NL summary 280. The instruction is provided in any suitable format using data and/or metadata. This information is available to and/or sent to the generating code 216 for use in generating a user entity-specific (e.g., user entity-tailored) summary 280 at the summarization process 314 (FIG. 4).

However, first, the parsing code 210 generally parses text of the alert 250 corresponding to an information technology (IT) abnormality incident 248, resulting in a parsed version of the alert data (e.g., the incident information 250X). This parsing comprises identifying varying portions of natural language of the incident information 250X as being nouns, adjectives and/or other elements of natural language.

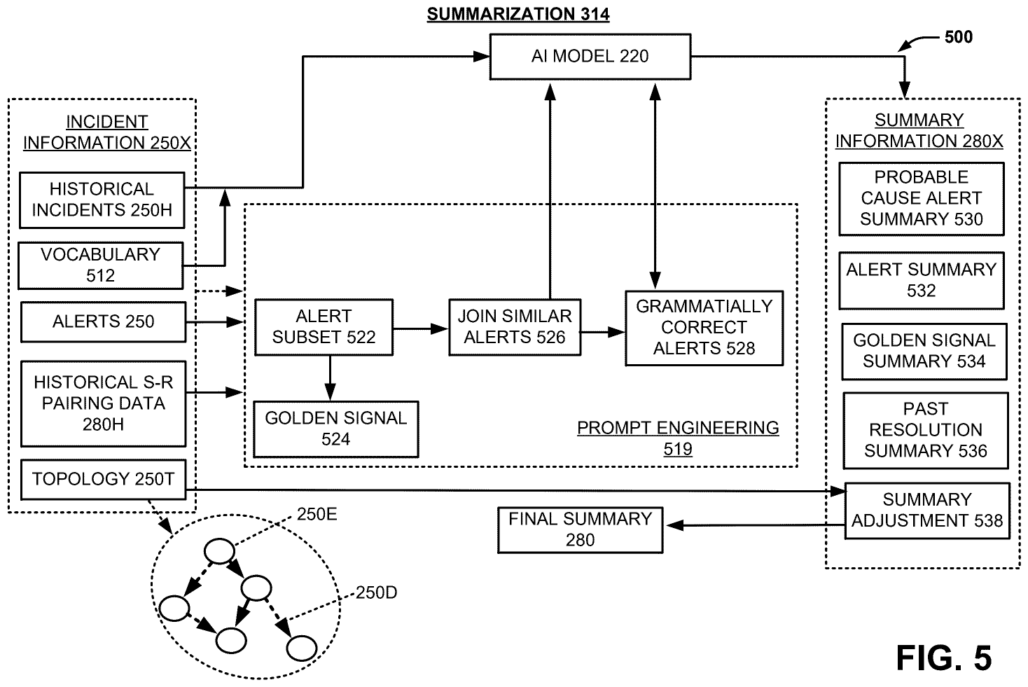

Turning to FIG. 5, in one or more embodiments, the parsing further includes one or more prompt engineering processes 519. These prompt engineering processes 519 include use of the incident information 250x to generate and/or determine a set of resources 520, alert subsets 522 and/or golden signals 524 (e.g., KPI's of the system in which the incident 248 occurred).

In one or more embodiments, the parsing code 210 employs the multistage AI model 220, such as a natural language (NL) AI model 220A, to generate sentences and/or phrases based on accepted grammatical rules. As illustrated, the pairing code 214 generates and/or employs a vocabulary 512 of computer system properties based on the incident information 250X. Any one or more aspects of such vocabulary 512 are obtained from a suitable vocabulary database, such as the alert/prompt/historical database 256. For example, the alert/prompt/historical database 256 comprises various aspects of information corresponding to a same incident that has occurred one or more times as one or more historical incidents 248H.

In one or more embodiments, the parsing code 210 and/or multistage AI model 220 filter the incident information 250X to remove one or more phrases and/or sentences that do not include and/or that do not refer to one or more golden signals as described above, e.g., error, saturation, latency and/or traffic, without being limited thereto.

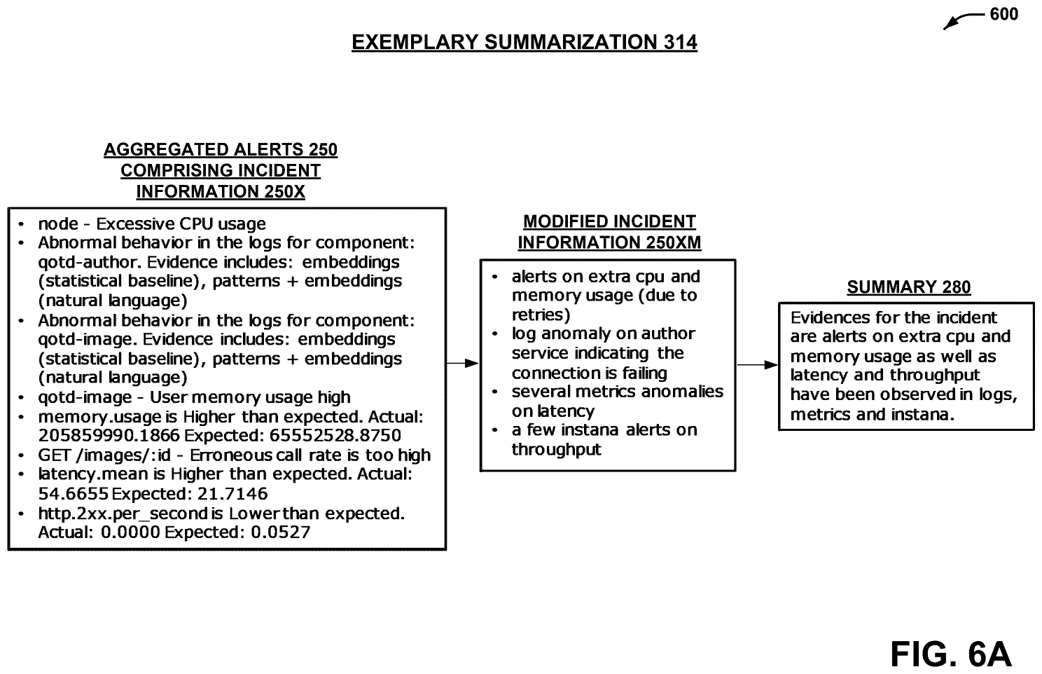

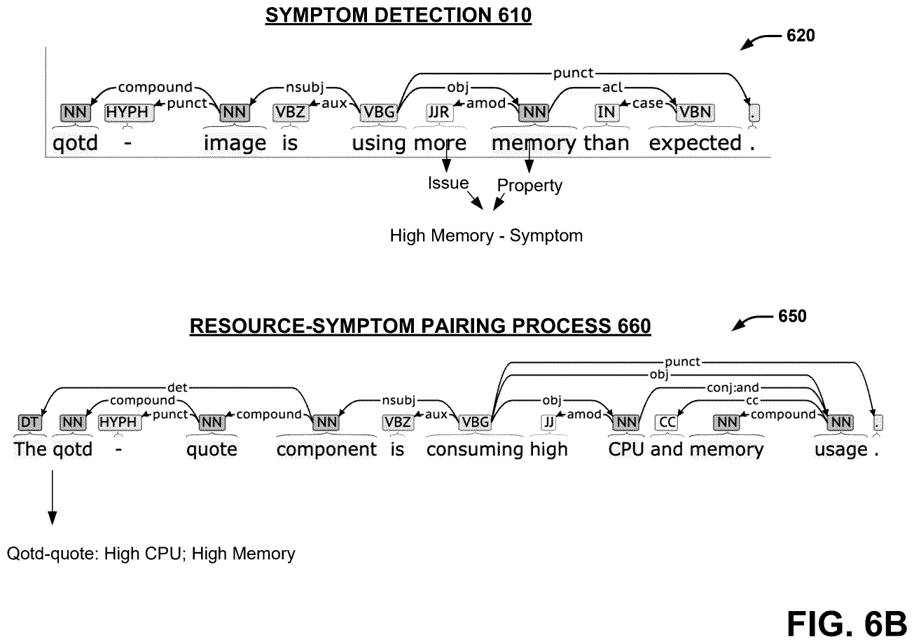

As a result, modified alert information 250XM is generated. See, for example FIG. 6A, illustrating modified incident information 250XM having grammatically accepted sentences and/or phrases based on the original incident information 250X.

Also using the modified incident information 250XM, the pairing code 214 performs a set of pairing processes to identify a symptom of the incident 248, a resource corresponding to causation of the incident 248 and a symptom-resource pairing (S-R pairing) 280P based on the symptom and resource identified.

For example, looking to FIG. 6B, and also simultaneously referring to FIG. 5, illustrated are an exemplary symptom detection 610 and exemplary resource-symptom pairing process 660 using exemplary natural language sentence portions 620 and 650. It is noted that “qotd” at these sentence portions 620 and 650 refers to “question of the day” or other inquiry language. As illustrated, the pairing code 214 generates and/or employs a vocabulary 512 of computer system properties based on the modified incident information 250XM. Any one or more aspects of such vocabulary 512 are obtained from a suitable vocabulary database, such as the alert/prompt/historical database 256. The pairing code 214 further matches one or more nouns of natural language sentences, generated based on the alert data, with the vocabulary 512.

In addition, the pairing code 214 identifies at least one adjective that is the symptom. This identification of the at least one adjective that is the symptom occurs from the natural language sentences based on the matching and based on use of the alert/prompt/historical database 256 (also referred to at FIG. 2 as a historical incident and ground truth database 256). In connection therewith, at FIG. 6B, an exemplary symptom of high memory usage has been identified based on natural language processing that is performed at least partially by the pairing code 214 on the information (e.g., text) of the alert. In one or more embodiments, the pairing code 214 employs the multistage AI model 220, such as a pairing AI model 220Y, for the natural language pairing processing and/or employs any other natural language processing model and/or processor communicatively accessible to the heterogeneous data analysis system 202. Relative to FIG. 6B, CC refers to coordinating junction, DT refers to determiner, JJR refers to adjective, comparative, NN refers to nouns, singular, NNS refers to noun, plural, VBG refers to verb, gerund, or present participle, and VBZ refers to verb, present tense, third person singular.

Thereafter, the pairing code 214 maps the symptom to a resource using dependency parsing of the natural language sentences. For example, at FIG. 6A, an exemplary S-R pairing is high memory usage (symptom) caused by high central processing unit (CPU). The high CPU is the resource. In one or more cases, the term “high” refers to when usage of memory is close to a given size of the memory, more than a given threshold and/or more than an average usage in normal condition, when no incident is occurring.

For example, in one or more embodiments, the pairing code 214 compares one or more historical S-R pairing data 280H to the modified incident information 250XM, which aids in generating the S-R pairing 280P. The historical S-R pairing data 280H comprises causation and/or resolution data corresponding to a historical incident 248H. The historical S-R pairing data 280H is obtained from the alert/prompt/historical database 256, for example.

Further, the generating code 216, based on the instruction 255, generates the NL summary 280 using the multistage AI model 220, e.g., summarizing AI model 220Z, to produce full grammatically-accepted phrases and/or sentences. The phrases and/or sentences in at least some embodiments are based on user-specific tailoring. That is, in one or more embodiments, the summary 280 is tailored to one or more templates/preferences of a specified user entity. The templates/preferences comprise any one or more of display templates, information classifications (types of information to be provided), information organizations, wording and/or the like. In one or more cases, the templates/preferences align with one or more different goals that are associated with and/or selected relative to the one or more different specified user entities. These goals comprise, but are not limited to, business impact, service level objective violation, defects, manufacturing or process gaps, probable cause, invoice generation, root cause, quality control and/or the like. In this way, by the tailoring, the NL summary 280 is able to be more quickly digested and/or addressed by a user entity.

The NL summary 280 comprises an S-R pairing 280P corresponding to the alert 250 and based on the modified incident information 250XM and/or on a topology of keywords of the alert 250. These keywords are the vocabulary, nouns and/or adjectives of the modified incident information 250XM that are employed by the pairing code 214 for the S-R pairing process 660.

In one or more embodiments, the generating code 216 and/or multistage AI model 220 filter the incident information 250X and/or modified incident information 250XM to remove and/or merge one or more duplicate alert and/or anomaly/incident references.

In one or more embodiments, the multistage AI model 220 employs comparative graph connectivity distances 250D (FIG. 5), e.g., distances between elements of a topology of keywords of the incident information 250X and/or modified incident information 250XM to determine and/or describe additional information about a flow of occurrence of the incident 248 in the NL summary 280. For example, in one or more cases, distances between the keywords are determined based on vector embeddings representing the keywords and/or on a cosine similarity analysis of those vector embeddings. The vector embeddings are determined by the parsing code 210 when analyzing the incident information 250X. If one or more vector embeddings are not available or are determined, the alert/prompt/historical database 256 is searched and/or queried based on historical topology corresponding to one or more historical incidents 248H. In one or more cases, number of hops between nodes of the topology help provide a graph connectivity distance in one or more embodiments.

In one or more embodiments, few-shot in-context instruction learning is employed, such as employing the NL AI model 220A by the generating code 216. The NL AI model 220A obtains as input an alert subset 522, a subset of golden signals 524 and/or a subset of anomalies that can be included in the alert subset 522 or employed separately. As noted above, various aspects of the incident information 250X and/or modified incident information 250XM are employed, including, but not limited to, heterogeneous data thereof for alerts, anomalies, topology, logs, gold signals, and/or other derived cues.

In one or more embodiments, alerts are divided into two sets—one set of probable cause alerts already identified by an existing ITOps system and another set of alerts with all of the remaining alerts. In one or more embodiments, some of the alerts and/or some portion of the alerts are filtered out by removing sentences in the alert description/text that do not contain any golden signal or resource name. For example, the second sentence of the following alert text is dropped “Abnormal behavior in the logs for the component: qotd-author. Evidence includes: embeddings (statistical baseline), patterns+embeddings (natural language),” as the second sentence does not contain any golden signal or resource name. In one or more embodiments, similar alerts from different end-points and/or resources are combined together to form a single alert 250.

In one or more embodiments, one or more sub-summaries are generated, e.g., by the generating code 216 employing the NL AI model 220A. For example, a probable cause summary, alert summary and/or golden signal summary are generated. One or more of these sub-summaries are aggregated with one another or with the one or more templates and/or user entity preferences from the entity information database 254. The various AI models such as the NL AI model 220A are in some embodiments large language models. These sub-summaries include grammatically correct sentences. In some instances, the greedy method is implemented with a multi-task finetuned multilingual language machine learning model to generate better sentences. A query as a triplet is built, e.g., (instruction, input output), using three scenarios for few-shot learning. An instruction such as “Task Description: Generate grammatically correct sentence in English” is used as part of the prompt engineering. In one or more embodiments, golden signals detected from a context in a sentence are mentioned through a slot-filling technique. In one or more embodiments, sub-summaries (e.g., those from a probable cause alert list, the alert list, and/or the detected golden signals) are concatenated to produce a final NL summary 280.

Next, prior to output of the summary 280, and/or after output of the summary 280, the verifying code 222 analyzes summary information 280X of the summary 280 to provide information that is used for any summary adjustment 538 and/or AI model retraining 472. In one or more embodiments, the processes performed by the verifying code 222 are performed relative to more than just the S-R pairing 280P of the summary 280, such as for interim language of the summary 280 and/or for a full among of the natural language of the summary 280.

The verifying code 222 and/or the feedback code 224 employ one or more feedback processes that employ feedback 262 to provide the inputs for a summary adjustment 538 and/or AI model retraining 472 to be instructed by the verifying code 222. That is, the verifying code 222 and feedback code 224 perform processes closely related to one another and/or including back-and-forth data sending and/or receiving. In one or more embodiments, the verifying code 222 and feedback code 224 are combined and/or their processes performed by a single code (e.g., a verifying/feedback code). In one or more embodiments, the feedback processes comprise a behavioral feedback evaluation 318 based on behavioral feedback 262A from one or more user entities and an AIOps metric feedback evaluation 316 based on AIOps metric feedback 262B.

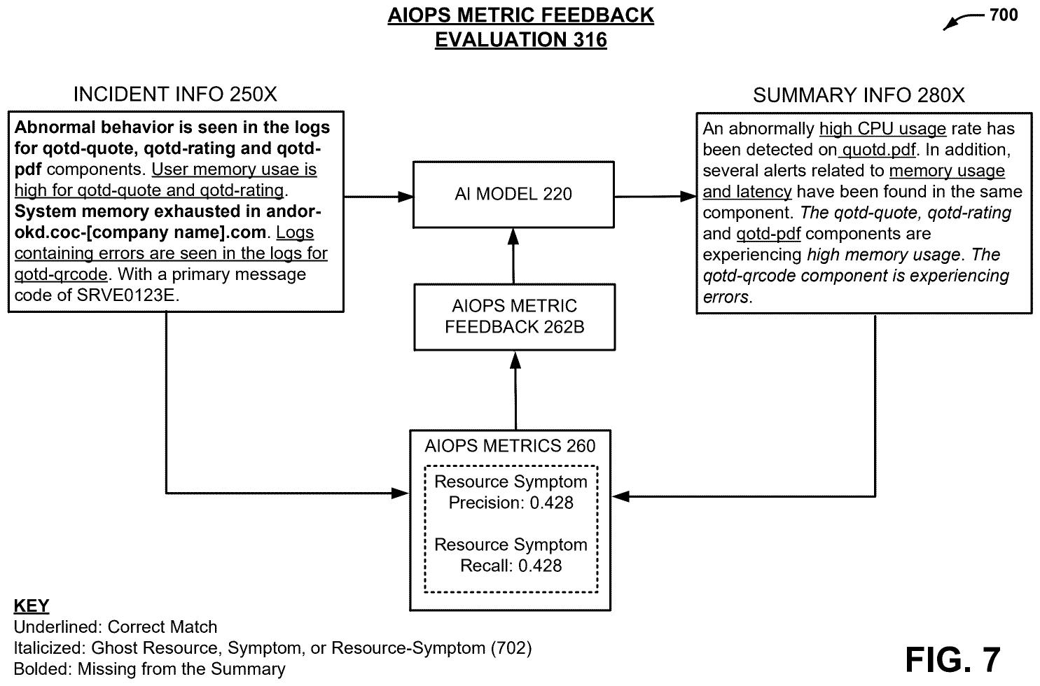

Turning first to the verifying code 222 and to the AIOps metric feedback evaluation 316, this verifying code 222 parses the natural language summary 280 and compares a result of the parsing of the NL summary 280 to the alert data 250X. For example, referring to FIG. 7, various aspects of the incident information 250X are compared to the summary information 280X to identify correct matches to one another, to identify hallucination/ghost aspects 702, and/or to identify elements missing from the NL summary 280 but present in the incident information 250X. As used herein, a “ghost aspect” or hallucination refers to an artificial intelligence (AI) hallucination, which is defined as an incorrect and/or misleading result generated by an AI element, such as an AI model. Such hallucination is caused by any one or more factors comprising, but not limited to, insufficient training data, one or more incorrect assumptions employed by the AI element, and/or a bias comprised by the training data.

That is, based on a result of the parsing, the verifying code 222 identifies an aspect (e.g., ghost resource-symptom, resource and/or symptom 702) of the NL summary 280 that does not correlate to the alert data (e.g., incident information 250X). In one or more embodiments, such identification is based on a data correlation threshold 806. In one or more embodiments, the data correlation threshold 806 is a precision threshold and/or recall threshold based on any one or more AIOps metrics 260 as described below. Accordingly, the verifying code 222 checks back and identifies a ghost resource or symptom 702 that fails to correlate to the alert data 250X based on an AIOps metric 260.

In one or more embodiments, AIOps metrics 260 comprise one or more of probable cause resource precision (PRCP), probable cause resource recall (PCRR), alert resource precision (ARP), and/or alert resource recall (ARR). PRCP refers to a fraction or more of resources reported in the summary 280 that are present in a probable cause alerts list (PCA list), such as those generated by the verifying code 222 during the parsing. PCRP=1 indicates that the summary is not referring to resources that have no issues, e.g., no ghost aspect is present in the summary. PCRR refers to a fraction or more of resources present in the PCA list that are reported in the summary 280. A high PCRR indicates that the summary 280 has a comprehensive overview of the PCA and specified details have not been omitted that aid in downstream tasks (e.g., remedy generation 322). The alert resource precision (ARP) metric refers to a fraction of resources reported in the summary that are present in the Alerts list. The alert resource recall (ARR) metric refers to a fraction of the resources in the Alerts list that were reported in the summary.

In one or more embodiments, comparative graph connectivity distances 250D (FIG. 5), e.g., distances between elements 250E of the topology 250T, are employed to verify the S-R pairing 280P and/or any other NL aspect of the summary information 280X. In one or more cases, distances between the keywords are determined based on vector embeddings representing the keywords. The vector embeddings are determined by the verifying code 222 when analyzing (e.g., parsing) the NL summary 220. If one or more vector embeddings are not available or are determined, the alert/prompt/historical database 256 is searched and/or queried based on historical ground truth corresponding to one or more historical incidents 248H.

For example, where topology keywords corresponding to a first set of distances are employed in the incident information 250X, but topology keywords corresponding to a second and different set of distances are employed in the summary information 280X, a summary adjustment and/or refining 320 is suggested. This refining is performed to address a difference between connectivity distance values between the first set of distances and the second set of distances. This refining helps correct incorrect or undesired used of higher or lower keyword relationships in the summary information 280X as compared to in the incident information 250X. In some embodiments, these distances 250D provide information about future vulnerable services and about a blast radius. A blast radius refers to the distance/number (with respect to the topological relationships) of nodes that are affected by a particular incident.

Additionally, and/or alternatively, the feedback code 224 obtains behavioral feedback data 262A corresponding to user entity feedback provided by a user entity 310 of the system (e.g., heterogenous data analysis system 202). In at least some embodiments the behavioral feedback data 262A comprises a quantitively defined sentiment corresponding to the user entity feedback. In one or more embodiments, the feedback code 224 generates a feedback prompt to solicit feedback from a user. The feedback prompt in one or more embodiments includes a graphical user interface with one or more response solicitations such as questions which are displayed on a display screen of a user in a manner which allows feedback from the user to be input into the same computer and stored for analysis. As used herein, a “sentiment” refers to a tone, choice of wording in the user entity feedback, etc., from which a numerical value is generated (e.g., by the feedback code 224) defining the sentiment. In one or more embodiments, the numerical value is generated based on a set of rules, and/or by further employing feedback determining AI model 220ZZ that generates the numerical value based on the entity feedback. With such a feedback determining AI model 220ZZ, the entity feedback is input into the AI model 220ZZ and, in response, the AI model 220ZZ outputs the numerical value. The AI model 220ZZ performs classification in such embodiments. In one or more embodiments, the correlation threshold 806, and/or another threshold, for use in determining a ghost aspect 702 is based on such numerical value.

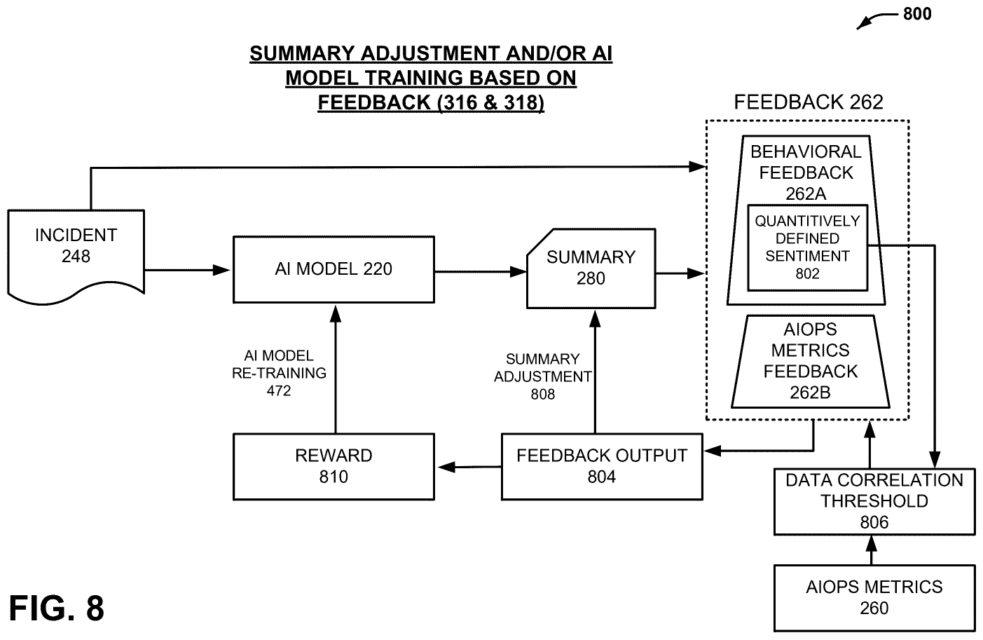

Using the feedbacks 262A and 262B output (together referred to as feedback output 804 as shown in FIG. 8) from the verifying code 222 and from the feedback code 224, an adjusting/refining (e.g., a goal definitions and/or mappings refining 320) and/or a retraining 472 of the multistage AI model 220 are directed and/or suggested by the verifying code 222 and/or feedback code 224.

For example, in response to the feedback(s) that is/are received, the generating code 216 adjusts/refines one or more aspects of the summary 280 (e.g., performing one or more adjusting 320), even adjusting the S-R pairing 280P, resulting in a re-generation of the summary 280 for the user entity. It is noted, in one or more embodiments, a preference-based and/or template-based adjustment is made and/or directed by the generating code 216 to the summary 280 (e.g., separate from a subject matter adjustment related to the incident information 250X), thereby resulting in an adjustment of the tailoring of the summary 280. For example, such tailoring adjustment is performed based on one or more behavioral feedbacks 262A. As a result, an NL summary 280 having an increased accuracy and/or precision of one or more S-R pairings 280P is provided in an automated manner via the system.

For another example, in response to the feedback(s) that is/are received, the training code 226 performs a retraining 472 of the multistage AI model 220 using the training processes 470 describe above. The retraining 472 results in increased understanding by the multistage AI model 220 of new and/or changed symptoms, resources and/or symptom-resource pairings, to thereby allow for more accurate S-R pairings 280 to be generated with more precision than before the re-training 472.

In one or more embodiments, a reward 810 is determined by the training code 226, based on the feedback output 804. The reward 810 is employed to weight one or more aspects of the multistage AI model 220 retraining 472. For example, the multistage AI model 220 is trained to respond to a reward 810 and to adjust one or more functions, e.g., NL determining, NL generating, summary generating, sub-summary generating and/or the like based on the reward 810.

Using these feedbacks, summary adjusting and/or re-training processes, the heterogeneous data analysis system 202 is self-improving to result in higher accuracy and/or higher precision S-R pairing 280P generation and summary 280 generation. These advancements build off of employing existing frameworks for analyzing heterogenous data applicable to computer system incidents in order to achieve these advancements.

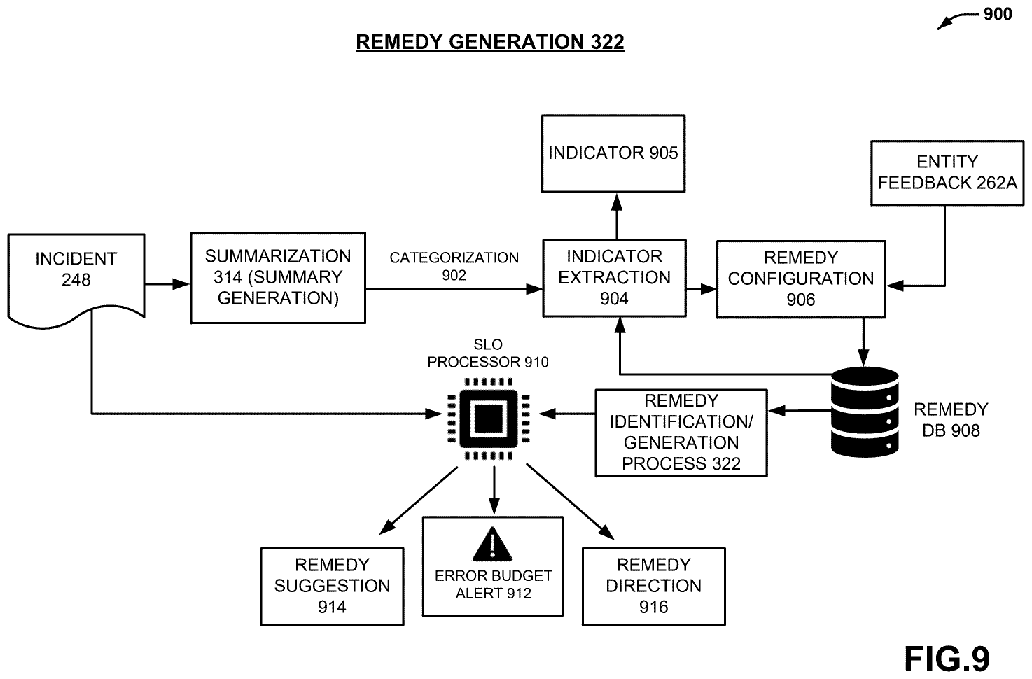

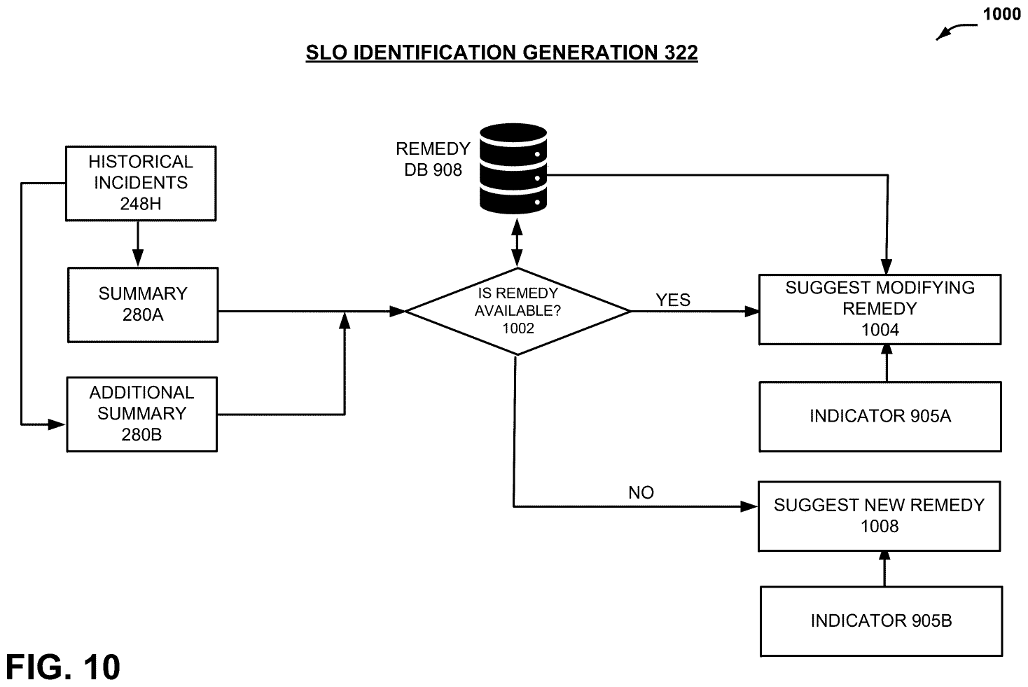

Turning now to FIGS. 9 and 10 and to respective schematic diagrams 900 and 1000, in one or more embodiments, the remedy code 228 of the heterogeneous data analysis system 202 generates an extended output 282 based on the NL summary 280. In one or more embodiments, the extended output 282 includes a remedy 282X comprising a method/process for addressing the symptom of the symptom-resource pairing 280P. In one or more embodiments, the generating of the remedy (e.g., remedy configuration 906) is based on a weighted indicator (e.g., indicator 905), determined (e.g., indicator extraction 904) from the natural language summary 280, and which is applicable to the resource of the system-resource pairing 280P. In one or more embodiments, the generating of the remedy is based on a quantity of correlations within the natural language summary 280 (e.g., based on categorization 902) to the indicator 905 that are applicable to the resource of the system-resource pairing 280P. As used herein, the categorization 902 refers to identification of different indicator 905 based on different keywords of the NL summary 280. In use, one or more of such indicator 905 are extracted during the indicator extraction 904 based on the categorization 902.

Based on the indicator 905 extracted, one or more remedies 282X are identified and/or generated (e.g., remedy identification/generation process 322) by the remedy code 228, as defined subsequently. In one or more embodiments, a remedy database 908 of optional, historical and/or possible remedies 282X is employed for this remedy identification/generation process 322.

In one or more embodiments, the remedy code 228 generates a remedy suggestion 914 in any suitable format, such as a NL format, to be reviewed, e.g., by a user entity. The remedy suggestion 914 comprises one or more steps and/or processes for addressing the incident 248. Additionally, and/or alternatively, the remedy code 228 generates a remedy direction 916 to be sent to and/or obtained by the computer system comprising the incident 248. The remedy direction 916 comprises one or more steps and/or processes for addressing the incident 248. Different from a remedy suggestion 914, the remedy direction 916 is sent to the computer system comprising the incident 248 without user entity feedback or approval.

Information for generating a remedy suggestion 914 and/or remedy direction 916 includes, but is not limited to, one or more remedies employed for a historical incident 248H, such as obtained rom the remedy database 908. Examples of a remedy suggestion 914 and/or remedy direction 916 include, but are not limited to, changing the memory allotment (e.g., increasing the memory allotment by, for example, 12%, 20%, 25%, 30%, etc.) and changing the CPU availability (e.g., increasing the CPU availability). In one or more embodiments, a new remedy is generated by the remedy code 228 for use in a remedy suggestion 914 and/or remedy direction 916.

Turning next to FIG. 10, the remedy identification/generation process 322 is further illustrated using an exemplary case. For example, at decision step 1002, the remedy code 228 determines if a remedy is able to be generated/identified, such as from the remedy database 908, based on the NL summary. If yes, in one or more cases, the identified remedy is modified (step 1004), such as based on an indicator 905A. If no, in one or more cases, a new remedy is suggested (e.g., step 1008), such as based on an indicator 905B.

Also referenced at FIG. 10 is the ability of the remedy code 228 to digest two or more NL summaries (e.g., 280A and 280B) to generate/identify a common remedy 282X.

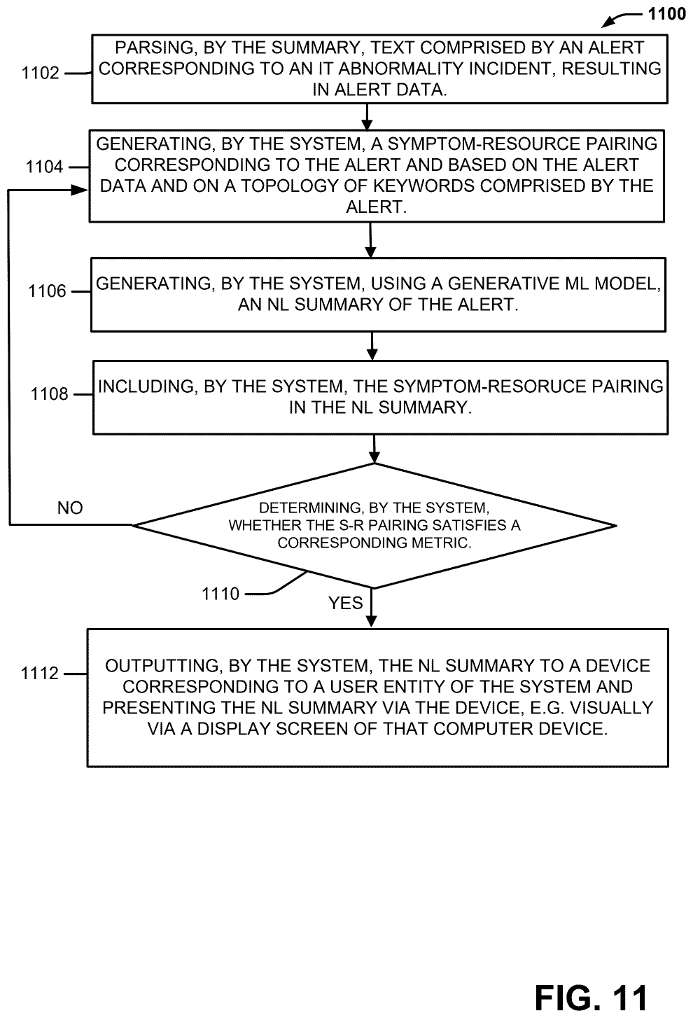

As a summary of the above-detailed steps that are performed by the heterogeneous data analysis system 202, FIG. 11 illustrates a flow diagram of an example, non-limiting method 1100 that provides a process for goal-driven summarization of faults of a computer system (e.g., physical, cloud-based and/or virtual, without being limited thereto), based on heterogenous multi-modal data, in accordance with one or more embodiments described herein, such as the non-limiting system 200 of FIG. 2. In one or more embodiments, while the non-limiting method 1100 is described relative to the non-limiting system 200 of FIG. 2, the non-limiting method 1100 is applicable also to other systems described herein, such as the non-limiting system 100 of FIG. 1. Repetitive description of like elements and/or processes employed in respective embodiments is omitted for sake of brevity.

At 1102, the non-limiting method 1100 comprises parsing, by a system operatively coupled to a processor (e.g., parsing code 210), text comprised by an alert (e.g., alert 250) corresponding to an information technology (IT) abnormality incident (e.g., incident 248), resulting in alert data (e.g., incident info 250X).

At 1104, the non-limiting method 1100 comprises generating, by the system (e.g., generating code 216), using a generative machine learning (ML) model, a natural language summary (e.g., NL summary 280) of the alert.

At 1106, the non-limiting method 1100 comprises generating, by the system (e.g., pairing code 214), a symptom-resource pairing (e.g., S-R pairing 280P) corresponding to the alert.

At 1108, the non-limiting method 1100 comprises including, by the system (e.g., generating code 216), the symptom-resource pairing in the NL summary.

At 1110, the non-limiting method 1100 comprises determining, by the system (e.g., verifying code 222), whether the S-R pairing satisfies a corresponding metric (e.g., AIOps metric 260). If yes, the non-limiting method proceeds to step 1112. If not, the non-limiting method proceeds back to step 1106 for additional generating.

At 1112, the non-limiting method 1100 comprises outputting, by the system (e.g., generating code 216), the NL summary to a device corresponding to a user entity of the system and presenting the NL summary via the device, e.g., visually via a display screen of that computer device.

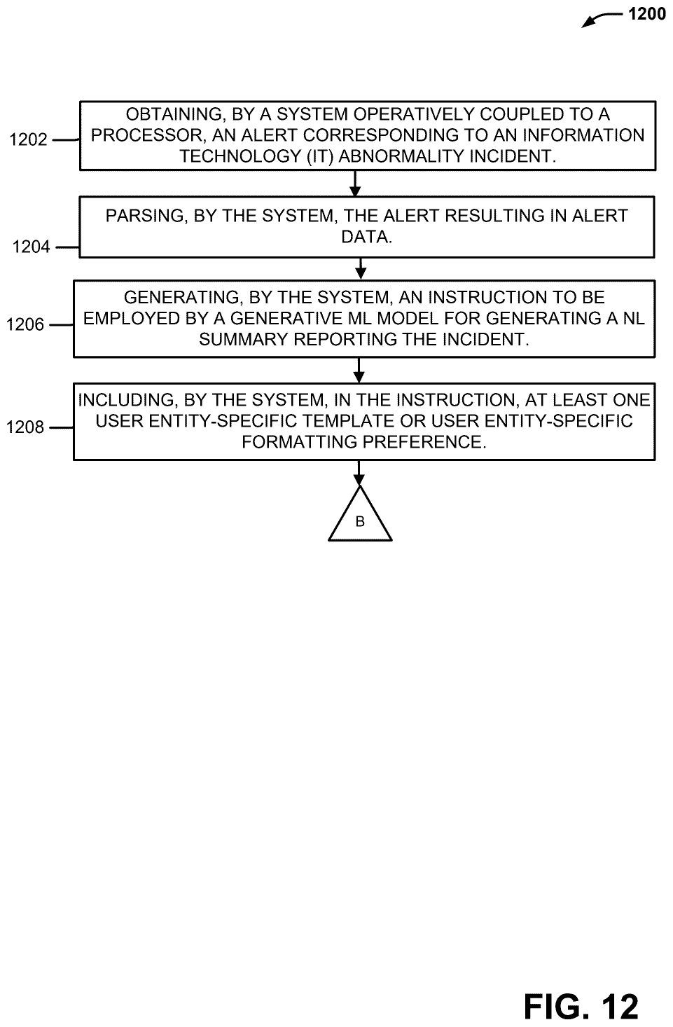

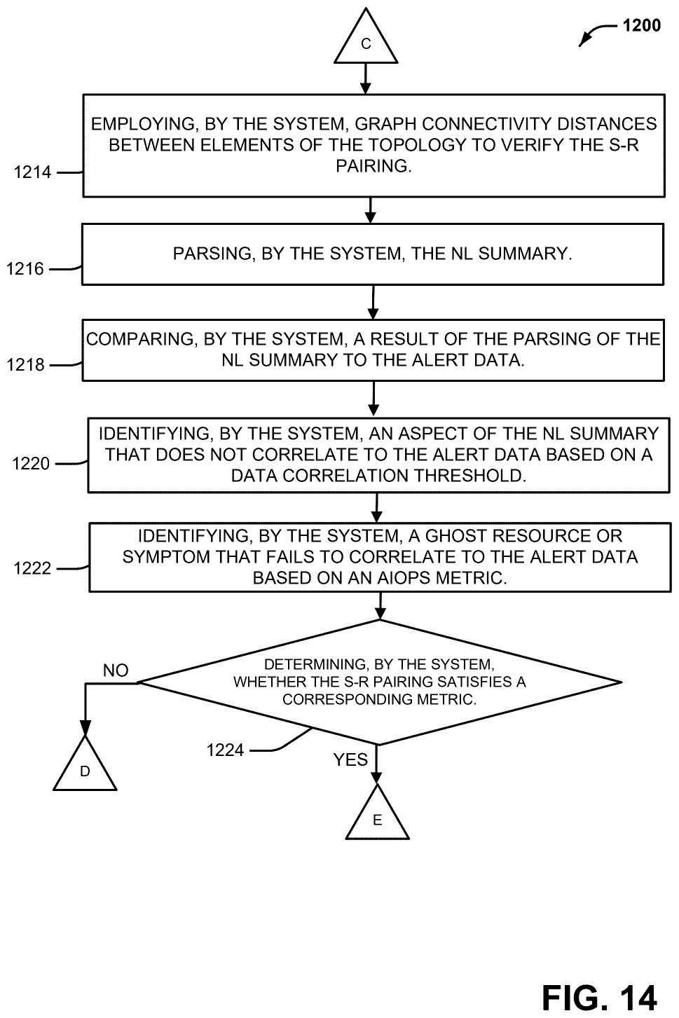

As a summary of the above-detailed steps that are performed by the heterogeneous data analysis system 202, FIGS. 12 to 15 illustrate flow diagrams of an example, non-limiting method 1200 that provides a process for goal-driven summarization of faults of a computer system (e.g., physical, cloud-based and/or virtual, without being limited thereto), based on heterogenous multi-modal data, in accordance with one or more embodiments described herein, such as the non-limiting system 200 of FIG. 2. In one or more embodiments, while the non-limiting method 1200 is described relative to the non-limiting system 200 of FIG. 2, the non-limiting method 1200 is applicable also to other systems described herein, such as the non-limiting system 100 of FIG. 1. Repetitive description of like elements and/or processes employed in respective embodiments is omitted for sake of brevity.

At 1202, the non-limiting method 1200 comprises obtaining, by a system operatively coupled to a processor (e.g., obtaining code 208), an alert (e.g., alert 250) corresponding to an information technology (IT) abnormality incident (e.g., incident 248).

At 1204, the non-limiting method 1200 comprises parsing, by the system (e.g., parsing code 210), the alert resulting in alert data (e.g., parsed incident information 250X).

At 1206, the non-limiting method 1200 comprises generating, by the system (e.g., instructing code 212), an instruction (e.g., instruction 255) to be employed by a generative ML model (e.g., multistage AI model 220) for generating a natural language summary (e.g., NL summary 280) reporting the incident.

At 1208, the non-limiting method 1200 comprises including, by the system (e.g., instructing code 212), in the instruction, at least one user entity-specific template or user entity-specific formatting preference (e.g., corresponding to entity information database 254 and/or to catalog 312 of entities, goal definitions and preferences stored at the database 254).

At 1210, the non-limiting method 1200 comprises generating, by the system (e.g., pairing code 214), a system-resource pairing (e.g., S-R pairing 280P) for the NL summary.

At 1210A, the non-limiting method 1200 comprises generating, by the system (e.g., pairing code 214), a vocabulary (e.g., vocabulary 512) of computer system properties.

At 1210B, the non-limiting method 1200 comprises matching, by the system (e.g., pairing code 214), nouns of NL sentences, generated based on the alert data, with the vocabulary.

At 1210C, the non-limiting method 1200 comprises identifying, by the system (e.g., pairing code 214) at least one adjective from the NL sentences based on the matching and classifying this at least one adjective as a symptom.

At 1210D, the non-limiting method 1200 comprises mapping, by the system (e.g., pairing code 214), the symptom to the resource using dependency parsing of the NL sentences.

At 1210E, the non-limiting method 1200 comprises comparing, by the system (e.g., pairing code 214), historical S-R pairing data (e.g., historical S-R pairing data 280H) to the alert data, resulting in a determination, by the system (e.g., pairing code 214) of the S-R pairing.

At 1210F, the non-limiting method 1200 comprises using, by the system (e.g., pairing code 214), the historical S-R pairing data describing causation and resolution for a historical incident corresponding to the historical S-R pairing.

At 1212, the non-limiting method 1200 comprises generating, by the system (e.g., generating code 216), using the generative ML model, the NL summary (e.g., NL summary 280) of the alert comprising the S-R pairing corresponding to the alert and based on the alert data and on a topology (e.g., topology 250T) of keywords comprised by the alert.

At 1214, the non-limiting method 1200 comprises employing, by the system (e.g., verifying code 222), graph connectivity distances between elements of the topology to verify the S-R pairing.

At 1216, the non-limiting method 1200 comprises parsing, by the system (e.g., verifying code 222) the NL summary.

At 1218, the non-limiting method 1200 comprises comparing, by the system (e.g., verifying code 222), a result of the parsing of the NL summary to the alert data.

At 1220, the non-limiting method 1200 comprises identifying, by the system (e.g., verifying code 222), an aspect (e.g., ghost resource-symptom 702) of the NL summary that does not correlate to the alert data based on a data correlation threshold (e.g., data correlation threshold 806).

At 1222, the non-limiting method 1200 comprises identifying, by the system (e.g., verifying code 222), a ghost resource or symptom that fails to correlate to the alert data based on an AIOps metric (e.g., AIOps metrics 260).

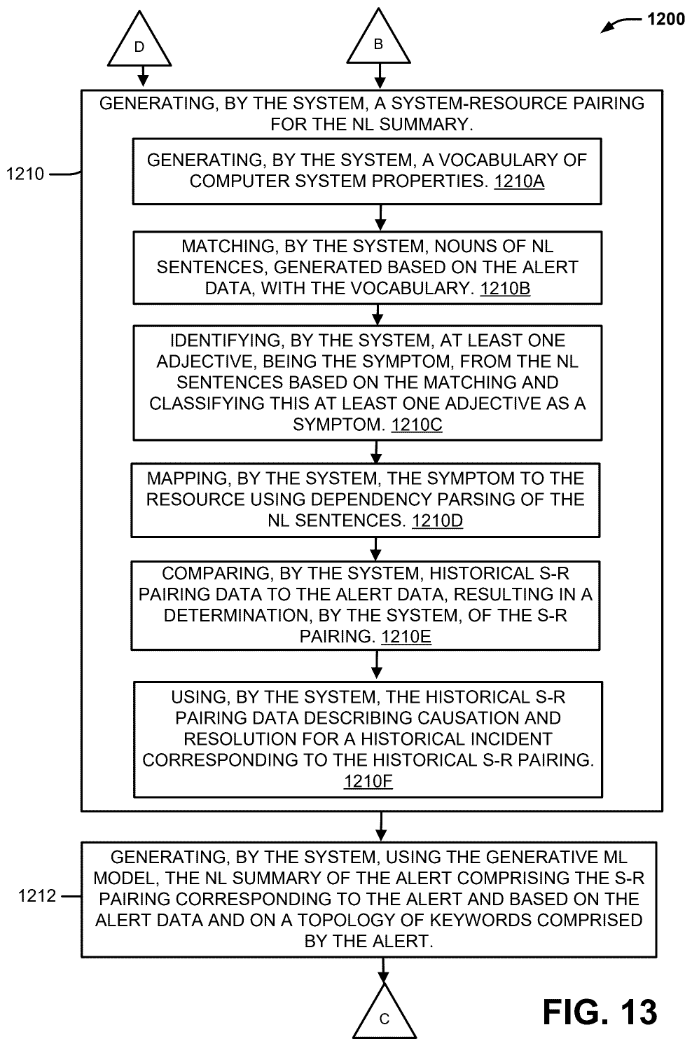

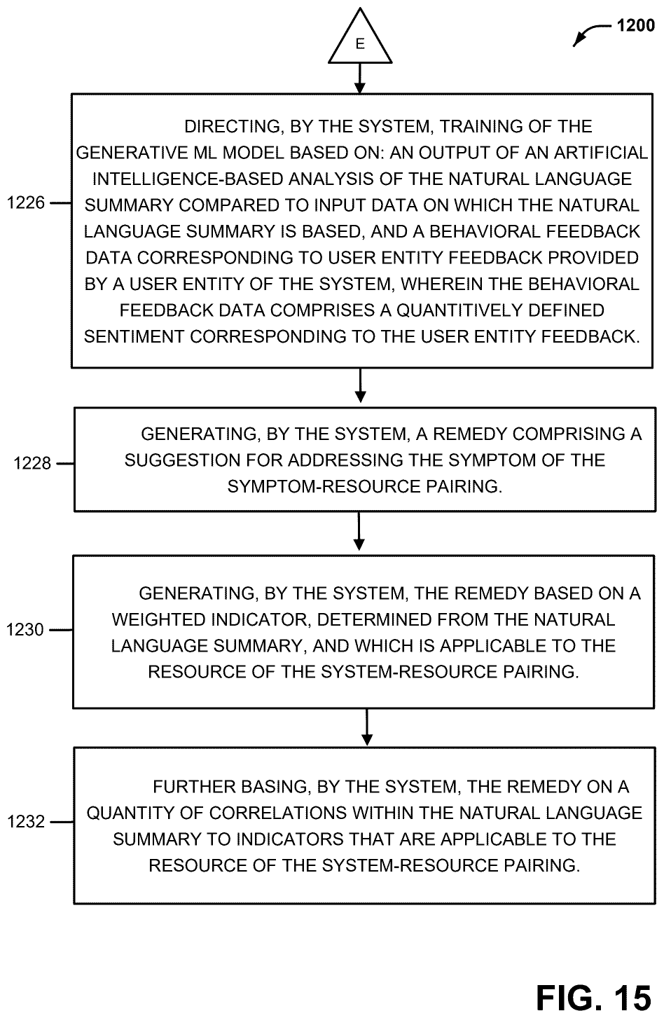

At 1224, the non-limiting method 1200 comprises determining, by the system (e.g., verifying code 222) whether the S-R pairing (S-R pairing 280P) satisfies a corresponding metric (e.g., AIOps metric 260 and/or metric corresponding to the behavioral feedback 262A). If yes, the non-limiting method 1200 proceeds to step 1226 (shown in FIG. 15). If not, the non-limiting method 1200 proceeds back to step 1210 (shown in FIG. 13) for re-generating of a system-resource pairing.

At 1226, the non-limiting method 1200 comprises directing, by the system (e.g., training code 226), training (e.g., retraining 472) of the generative ML model based on: an output (e.g., AIOps metric feedback 262B) of an AI-based analysis of the NL summary (e.g., AIOps metric feedback evaluation 316) compared to input data (e.g., parsed incident information 250X) on which the NL summary is based, and a behavioral feedback data (e.g., behavioral feedback data 262A) corresponding to user entity feedback provided by a user entity of the system (e.g., heterogeneous data analysis system 202) wherein the behavioral feedback data comprises a quantitively defined sentiment corresponding to the user entity feedback.

At 1228, the non-limiting method 1200 comprises generating, by the system (e.g., remedy code 228), a service level objective (e.g., remedy 282X) comprising a suggestion for addressing the symptom of the S-R pairing.

At 1230, the non-limiting method 1200 comprises generating, by the system (e.g., remedy code 228) the remedy based on a weighted service level indicator (e.g., indicator 905), determined from the natural language summary (e.g., indicator extraction 904), and which is applicable to the resource of the S-R pairing.

At 1232, the non-limiting method 1200 comprises further basing, by the system (e.g., remedy code 228), the remedy on a quantity of correlations within the NL summary to indicators that are applicable to the resource of the S-R pairing.

### ADDITIONAL SUMMARY

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more codes. Such systems and/or codes can include those codes or sub-codes specified therein, one or more of the specified codes and/or sub-codes, and/or additional codes. Sub-codes can be implemented as codes communicatively coupled to other codes rather than included within parent codes. One or more codes and/or sub-codes can be combined into a single code providing aggregate functionality. The codes can interact with one or more other codes not specifically described herein for the sake of brevity, but known by those of skill in the art.

In summary, a computer-implemented method includes parsing, by a processor set 106, 206, text 150X, 250X comprised by an alert 150, 250 corresponding to an information technology (IT) abnormality incident 148, 248, resulting in alert data. The processor set 106, 206, uses a generative machine learning (ML) model 120, 220 to generate a natural language summary 180, 280 of the alert 150, 250. The natural language summary 180, 280 includes a symptom-resource pairing 180P, 280P corresponding to the alert 150, 250 and is based on the alert data and on a topology 250T of keywords comprised by the alert 150, 250. In one or more embodiments, the computer-implemented method further comprises employing, by the processor set 106, 206, graph connectivity distances 250D between elements 250E of the topology 250T to verify the symptom-resource pairing 180P, 280P.

That is, put another way, using the one or more embodiments described herein, artificial intelligence for IT operations (AIOP or AI ITOPS) is employed to transform IT operational services by analyzing and bringing together data around a fault, thereby providing context to assist human decision for faster fault resolution. Insights include all alerts, topological information, detected anomalous behaviors, and probable cause identification including pieces of evidences, related to the fault. AI is able to provide these processes while drawing deeper insights and at a far greater scale than manually possible in existing frameworks, especially when considering the shrinking error budgets (e.g., allowed time an application is impacted) and exploding quantities of data relative to current developing computer systems.

A benefit of the one or more systems, computer program products and/or computer-implemented methods is an ability to automatically provide an incident abstract summarization based on heterogenous data from disparate sources without intensive manual input per incident abstract summarization. That is, automatic provision is provided using an artificial intelligence model (e.g., a machine learning model, neural network, etc.) based on one or more of a plurality of different inputs. These inputs comprise, but are not limited to, entity-specific behavioral feedback, artificial intelligence for information technology operations (AIOps) metric feedback and/or historical incident-based feedback.

Still another benefit of the one or more systems, computer program products and/or computer-implemented methods is an ability to provide user entity-specific summaries comprising varying templates, information classifications, information organizations, wording and/or the like. That is, the NL summary generated is tailored based on a database of user entity preferences.

Yet another benefit of the one or more systems, computer program products and/or computer-implemented methods is use of the summary, and a database of historical incident information, a database of indicators to further provide one or more remedies that is performed to address the incident/alert. In one or more embodiments, the one or more suggested remedies are included in the entity-specific summary.

Indeed, in view of the one or more embodiments described herein, a practical application of the one or more systems, computer-implemented methods and/or computer program products described herein is the obtaining of a natural language-based summary using a process that has informed feedback including entity-specific behavioral feedback, artificial intelligence for information technology operations (AIOps) metric feedback and/or historical incident-based feedback. These feedbacks are at least partially automatically provided and employed (e.g., automatic and/or manual input of behavioral feedback by a user entity), in-process workload-based neural network speedup. That is, the one or more embodiments described herein improve the performance of a natural language (NL) summary generation system, including the performance of an artificial intelligence model employed for the NL summary generation. Accordingly, the one or more embodiments described herein provide useful and practical applications of computers, thus providing enhanced (e.g., improved and/or optimized) artificial intelligence adjustment resulting in enhanced data analysis and prediction output. Overall, such computerized tools constitute a concrete and tangible technical improvement in the fields of artificial intelligence and neural networks.

Furthermore, one or more embodiments described herein are employed in a real-world system based on the disclosed teachings. For example, one or more embodiments described herein function with an artificial intelligence model (e.g., ML model, neural network, and/or the like) to adjust the artificial intelligence model (e.g., optimize the neural network for increased accuracy and/or precision, and/or for reduced improper symptom-resource pairings), where the artificial intelligence model is employed thereafter or in process of performance (e.g., in real time) for various inference actions relative to triggered alert notifications.

Moreover, one or more embodiments described herein are implemented in one or more domains to enable scaled summary and/or remedy output and/or AI model adjustment. Indeed, use of a system as described herein is scalable, such as where plural incidents are summarized at a same time using the one or more embodiments described herein.

The systems and/or devices have been (and/or will be further) described herein with respect to interaction between one or more codes. Such systems and/or codes include those codes or sub-codes specified therein, one or more of the specified codes and/or sub-codes, and/or additional codes. Sub-codes are implemented as codes communicatively coupled to other codes rather than included within parent codes. One or more codes and/or sub-codes are combined into a single code providing aggregate functionality. The codes interact with one or more other codes not specifically described herein for the sake of brevity, but known by those of skill in the art.

One or more embodiments described herein are, in one or more embodiments, inherently and/or inextricably tied to computer technology and cannot be implemented outside of a computing environment. For example, one or more processes performed by one or more embodiments described herein more efficiently, and even more feasibly, provide program and/or program instruction execution, such as relative to NL summary generation and generation process adjustment, as compared to existing systems and/or techniques. Systems, computer-implemented methods and/or computer program products providing performance of these processes are of great utility in the fields of heterogeneous data analysis and cannot be equally practicably implemented in a sensible way outside of a computing environment.

One or more embodiments described herein employ hardware and/or software to solve problems that are highly technical, that are not abstract, and that cannot be performed as mental acts by a human. For example, a human, or even thousands of humans, cannot efficiently, accurately and/or effectively automatically employ a generative AI model to generate a NL summary, verify accuracy and/or precision of the summary, and/or to update the generation process as the one or more embodiments described herein can provide these processes. Moreover, neither can the human mind nor a human with pen and paper conduct such processes, as conducted by one or more embodiments described herein.

In one or more embodiments, one or more of the processes described herein are performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or codes thereof are employed to solve new problems that arise through advancements in technologies mentioned above, employment of quantum computing systems, cloud computing systems, computer architecture and/or another technology.

One or more embodiments described herein are fully operational towards performing one or more other functions (e.g., fully powered on, fully executed and/or another function) while also performing one or more of the one or more operations described herein.

### Computing Environment Description

Turning next to FIG. 16, a detailed description is provided of additional context for the one or more embodiments described herein at FIGS. 1-15.

FIG. 16 and the following discussion are intended to provide a brief, general description of a suitable computing environment 1600 in which one or more embodiments described herein at FIGS. 1-15 are implemented, in one or more cases. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations are performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1600 contains an example of an environment for the execution of at least some of the computer code involved in performing the inventive methods, such as translation of an original source code based on a configuration of incident summarization code 1680. In addition to block 1680, computing environment 1600 includes, for example, computer 1601, wide area network (WAN) 1602, end user device (EUD) 1603, remote server 1604, public cloud 1605, and private cloud 1606. In this embodiment, computer 1601 includes processor set 1610 (including processing circuitry 1620 and cache 1621), communication fabric 1611, volatile memory 1612, persistent storage 1613 (including operating system 1622 and block 1680, as identified above), peripheral device set 1614 (including user interface (UI), device set 1623, storage 1624, and Internet of Things (IoT) sensor set 1625), and network module 1615. Remote server 1604 includes remote database 1630. Public cloud 1605 includes gateway 1640, cloud orchestration module 1641, host physical machine set 1642, virtual machine set 1643, and container set 1644.

COMPUTER 1601 may take the form of a desktop computer, laptop computer, tablet computer, smart phone, smart watch or other wearable computer, mainframe computer, quantum system or any other form of computer or mobile device now known or to be developed in the future that is capable of running a program, accessing a network or querying a database, such as remote database 1630. As is well understood in the art of computer technology, and depending upon the technology, performance of a computer-implemented method may be distributed among multiple computers and/or between multiple locations. On the other hand, in this presentation of computing environment 1600, detailed discussion is focused on a single computer, specifically computer 1601, to keep the presentation as simple as possible. Computer 1601 may be located in a cloud, even though it is not shown in a cloud in FIG. 16. On the other hand, computer 1601 is not required to be in a cloud except to any extent as may be affirmatively indicated.

PROCESSOR SET 1610 includes one, or more, computer processors of any type now known or to be developed in the future. Processing circuitry 1620 may be distributed over multiple packages, for example, multiple, coordinated integrated circuit chips. Processing circuitry 1620 may implement multiple processor threads and/or multiple processor cores. Cache 1621 is memory that is located in the processor chip package and is typically used for data or code that should be available for rapid access by the threads or cores running on processor set 1610. Cache memories are typically organized into multiple levels depending upon relative proximity to the processing circuitry. Alternatively, some, or all, of the cache for the processor set may be located “off chip.” In some computing environments, processor set 1610 may be designed for working with qubits and performing quantum computing.

Computer readable program instructions are typically loaded onto computer 1601 to cause a series of operational steps to be performed by processor set 1610 of computer 1601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1621 and the other storage media discussed below. The program instructions, and associated data, are accessed by processor set 1610 to control and direct performance of the inventive methods. In computing environment 1600, one or more instructions for performing the inventive methods may be stored in block 1680 in persistent storage 1613.

COMMUNICATION FABRIC 1611 is the signal conduction path that allows the various components and/or code of computer 1601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1612 is any type of volatile memory now known or to be developed in the future. Examples include dynamic type random access memory (RAM) or static type RAM. Typically, the volatile memory is characterized by random access, but this is not required unless affirmatively indicated. In computer 1601, the volatile memory 1612 is located in a single package and is internal to computer 1601, but, alternatively or additionally, the volatile memory may be distributed over multiple packages and/or located externally with respect to computer 1601.

PERSISTENT STORAGE 1613 is any form of non-volatile storage for computers that is now known or to be developed in the future. The non-volatility of this storage means that the stored data is maintained regardless of whether power is being supplied to computer 1601 and/or directly to persistent storage 1613. Persistent storage 1613 may be a read only memory (ROM), but typically at least a portion of the persistent storage allows writing of data, deletion of data and re-writing of data. Some familiar forms of persistent storage include magnetic disks and solid-state storage devices. Operating system 1622 may take several forms, such as various known proprietary operating systems or open-source Portable Operating System Interface type operating systems that employ a kernel. The code included in block 1680 typically includes at least some of the computer code involved in performing the inventive methods.

PERIPHERAL DEVICE SET 1614 includes the set of peripheral devices of computer 1601. Data communication connections between the peripheral devices and the other components and/or code of computer 1601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1623 may include components such as a display screen, speaker, microphone, wearable devices (such as goggles and smart watches), keyboard, mouse, printer, touchpad, game controllers, and haptic devices. Storage 1624 is external storage, such as an external hard drive, or insertable storage, such as an SD card. Storage 1624 may be persistent and/or volatile. In some embodiments, storage 1624 may take the form of a quantum computing storage device for storing data in the form of qubits. In embodiments where computer 1601 is required to have a large amount of storage (for example, where computer 1601 locally stores and manages a large database) then this storage may be provided by peripheral storage devices designed for storing large amounts of data, such as a storage area network (SAN) that is shared by multiple, geographically distributed computers. IoT sensor set 1625 is made up of sensors that can be used in Internet of Things applications. For example, one sensor may be a thermometer and another sensor may be a motion detector.

NETWORK MODULE 1615 is the collection of computer software, hardware, and firmware that allows computer 1601 to communicate with other computers through WAN 1602. Network module 1615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1615 are performed on the same physical hardware device. In other embodiments (for example, embodiments that utilize software-defined networking (SDN)), the control functions and the forwarding functions of network module 1615 are performed on physically separate devices, such that the control functions manage several different network hardware devices. Computer readable program instructions for performing the inventive methods can typically be downloaded to computer 1601 from an external computer or external storage device through a network adapter card or network interface included in network module 1615.

WAN 1602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1603 is any computer system that is used and controlled by an end user (for example, a customer of an enterprise that operates computer 1601) and may take any of the forms discussed above in connection with computer 1601. EUD 1603 typically receives helpful and useful data from the operations of computer 1601. For example, in a hypothetical case where computer 1601 is designed to provide a recommendation to an end user, this recommendation would typically be communicated from network module 1615 of computer 1601 through WAN 1602 to EUD 1603. In this way, EUD 1603 can display, or otherwise present, the recommendation to an end user. In some embodiments, EUD 1603 may be a client device, such as thin client, heavy client, mainframe computer, desktop computer and so on.

REMOTE SERVER 1604 is any computer system that serves at least some data and/or functionality to computer 1601. Remote server 1604 may be controlled and used by the same entity that operates computer 1601. Remote server 1604 represents the machine that collects and stores helpful and useful data for use by other computers, such as computer 1601. For example, in a hypothetical case where computer 1601 is designed and programmed to provide a recommendation based on historical data, then this historical data may be provided to computer 1601 from remote database 1630 of remote server 1604.

PUBLIC CLOUD 1605 is any computer system available for use by multiple entities that provides on-demand availability of computer system resources and/or other computer capabilities, especially data storage (cloud storage) and computing power, without direct active management by the scale. The direct and active management of the computing resources of public cloud 1605 is performed by the computer hardware and/or software of cloud orchestration module 1641. The computing resources provided by public cloud 1605 are typically implemented by virtual computing environments that run on various computers making up the computers of host physical machine set 1642, which is the universe of physical computers in and/or available to public cloud 1605. The virtual computing environments (VCEs) typically take the form of virtual machines from virtual machine set 1643 and/or containers from container set 1644. It is understood that these VCEs may be stored as images and may be transferred among and between the various physical machine hosts, either as images or after instantiation of the VCE. Cloud orchestration module 1641 manages the transfer and storage of images, deploys new instantiations of VCEs and manages active instantiations of VCE deployments. Gateway 1640 is the collection of computer software, hardware, and firmware that allows public cloud 1605 to communicate via WAN 1602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1606 is similar to public cloud 1605, except that the computing resources are only available for use by a single enterprise. While private cloud 1606 is depicted as being in communication with WAN 1602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1605 and private cloud 1606 are both part of a larger hybrid cloud.

### ADDITIONAL CLOSING INFORMATION

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system. In an aspect, a component can comprise and/or employ code.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable memory.

What has been described above includes mere examples of systems and computer-implemented methods. It is, of course, not possible to describe every conceivable combination of components, codes and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A computer-implemented method, comprising:
parsing, by natural language processing techniques, text of an alert corresponding to an information technology (IT) abnormality incident, resulting in alert data; and
generating, by a generative machine learning (ML) model, a natural language summary of the incident,
wherein the natural language summary comprises a symptom-resource pairing corresponding to the alert and is based on the alert data and on a topology of keywords of the alert.

2. The computer-implemented method of claim 1, further comprising:
employing, by a processor set, graph connectivity distances between elements of the topology to verify the symptom-resource pairing.

3. The computer-implemented method of claim 1, further comprising:
comparing, by the processor set, historical symptom-resource pairing data to the alert data, resulting in a determination, by the processor set, of the symptom-resource pairing,
wherein the historical symptom-resource pairing data comprises data describing causation and resolution for a historical incident corresponding to the historical symptom-resource pairing.

4. The computer-implemented method of claim 1, further comprising:
generating, by the processor set, the symptom-resource pairing, comprising:
generating, by the processor set, a vocabulary of computer system properties,
matching, by the processor set, nouns of natural language sentences, generated based on the alert data, with the vocabulary,
identifying, by the processor set, at least one adjective, being the symptom, from the natural language sentences based on the matching, and
mapping, by the processor set, the symptom to the resource using dependency parsing of the natural language sentences.

5. The computer-implemented method of claim 1, further comprising:
generating, by the processor set, an instruction to be employed by the generative ML model for generating the natural language summary,
wherein the instruction comprises at least one user entity-specific template or user entity-specific formatting preference.

6. The computer-implemented method of claim 1, further comprising:
parsing, by the processor set, the natural language summary;
comparing, by the processor set, a result of the parsing of the natural language summary to the alert data, and
identifying, by the processor set, an aspect of the natural language summary that does not correlate to the alert data based on a data correlation threshold.

7. The computer-implemented method of claim 1, further comprising:
comparing, by the processor set, the symptom-resource pairing of the natural language summary to the alert data; and
identifying, by the processor set, a ghost resource or symptom that fails to correlate to the alert data based on an artificial intelligence for IT operations (AIOps) metric.

8. The computer-implemented method of claim 1, further comprising:
directing, by the processor set, training of the generative ML model based on:
an output of an artificial intelligence-based analysis of the natural language summary compared to input data on which the natural language summary is based, and
a behavioral feedback data corresponding to user entity feedback provided by a user entity of the system,
wherein the behavioral feedback data comprises a quantitively defined sentiment corresponding to the user entity feedback.

9. The computer-implemented method of claim 1, further comprising:
generating, by the processor set, remedy a suggestion for addressing the symptom of the symptom-resource pairing,
wherein the generating of the remedy suggestion is based on weighted indicator data, determined from the natural language summary, and which is applicable to the resource of the symptom-resource pairing.

10. The computer-implemented method of claim 1, further comprising:
generating, by the processor set, remedy a suggestion for addressing the symptom of the symptom-resource pairing,
wherein the generating of the remedy suggestion is based on a quantity of correlations within the natural language summary to indicator data that are applicable to the resource of the symptom-resource pairing.

11. A computer system, comprising:
a processor set;
a set of one or more computer-readable storage media; and
program instructions, collectively stored in the set of one or more storage media, for causing the processor set to perform the following computer operations:
parsing text comprised by an alert corresponding to an information technology (IT) abnormality incident, resulting in alert data; and
generating, using a generative machine learning (ML) model, a natural language summary of the incident,
wherein the natural language summary comprises a symptom-resource pairing corresponding to the alert, and which is based on the alert data and on a topology of keywords comprised by the alert.

12. The computer system of claim 11, wherein the computer operations further comprise:
employing graph connectivity distances between elements of the topology to verify the symptom-resource pairing.

13. The computer system of claim 11, wherein the computer operations further comprise:
comparing historical symptom-resource pairing data to the alert data, resulting in a determination, by the processor set, of the symptom-resource pairing,
wherein the historical symptom-resource pairing data comprises data describing causation and resolution for a historical incident corresponding to the historical symptom-resource pairing.

14. The computer system of claim 11, wherein the computer operations further comprise:
generating the symptom-resource pairing, comprising:
generating a vocabulary of computer system properties,
matching nouns of natural language sentences, generated based on the alert data, with the vocabulary,
identifying at least one adjective, being the symptom, from the natural language sentences based on the matching, and
mapping the symptom to the resource using dependency parsing of the natural language sentences.

15. The computer system of claim 11, wherein the computer operations further comprise:
comparing the symptom-resource pairing of the natural language summary to the topology; and
identifying a ghost resource or symptom that fails to correlate to the topology based on a topology correlation threshold.

16. The computer system of claim 11, wherein the computer operations further comprise:
generating a remedy comprising a suggestion for addressing the symptom of the symptom-resource pairing,
wherein the generating of the remedy suggestion is based on a weighted indicator, determined from the natural language summary, and which is applicable to the resource of the symptom-resource pairing.

17. A computer program product, comprising:
a set of one or more computer-readable storage media; and
program instructions, collectively stored in the set of one or more storage media, for causing a processor set to perform computer operations comprising:
parsing text comprised by an alert corresponding to an information technology (IT) abnormality incident, resulting in alert data; and
generating, using a generative machine learning (ML) model, a natural language summary of the incident,
wherein the natural language (NL) summary comprises a symptom-resource pairing corresponding to the alert, and which is based on the alert data and on a topology of keywords comprised by the alert.

18. The computer program product of claim 17, wherein the computer operations further comprise:
employing graph connectivity distances between elements of the topology to verify the symptom-resource pairing.

19. The computer program product of claim 17, wherein the computer operations further comprise:
comparing historical symptom-resource pairing data to the alert data, resulting in a determination, by the processor set, of the symptom-resource pairing,
wherein the historical symptom-resource pairing data comprises data describing causation and resolution for a historical incident corresponding to the historical symptom-resource pairing.

20. The computer program product of claim 17, wherein the computer operations further comprise:
generating the symptom-resource pairing, comprising:
generating a vocabulary of computer system properties,
matching nouns of NL sentences, generated based on the alert data, with the vocabulary,
identifying at least one adjective, being the symptom, from the NL sentences based on the matching, and
mapping the symptom to the resource using dependency parsing of the NL sentences.
